(19) United States
(12) Patent Application Publication
(10) Pub. No.: US 2025/0285135 A1
(43) Pub. Date: Sep. 11, 2025

(54) GENERATIVE CONNECTIVITY AND PAYMENT SYSTEM ON A MULTI-LAYERED SOCIAL-COMMERCIAL NETWORK USING VIRAL AND NETWORK EFFECTS

(71) Applicant: InfluenceInk, Inc., Rancho Mission Viejo, CA (US)

(72) Inventors: Robert Towles, Rancho Mission Viejo, CA (US); Channing Corn, Austin, TX (US)

(73) Assignee: InfluenceInk, Inc., Rancho Mission Viejo, CA (US)

(21) Appl. No.: 18/598,671

(22) Filed: Mar. 7, 2024

(51) Int. Cl. G06Q 30/0226; G06Q 30/0241; G06Q 50/00

(52) U.S. Cl. CPC G06Q 30/0226; G06Q 30/0277; G06Q 50/01

(57) ABSTRACT

A computer-implemented method for determining a periodic payment to users of a social network including. The method includes associating users of a cloud-based social network into a Merkle tree structure based on an order of membership referrals as to which user referred which to the cloud-based social network. The method includes quantifying an amount of digital engagement that a first user has with the cloud-based social network through an individual impact score. The method includes attributing all users that were referred to the cloud-based social network by the first user into the first user's sub-network. The method includes quantifying an amount of digital engagement for all users within the first user's sub-network has with the cloud-based social network through a sub-network impact score. The method includes making a recurring electronic payment to the first user on a periodic basis utilizing the individual impact score and the sub-network impact score.

### FIELD

The present specification discloses technologies for cloud-based social and commercial networks regarding network effects and viral effects, payment architectures, generative connections between user-members of the network, and multi-layered networks with different layers for network referrals and commercial activities.

### BACKGROUND

The background description provided herein is for the purpose of generally presenting the context of the disclosure. The work of the presently named inventors, to the extent it is described in this background section, as well as aspects of the description that may not otherwise qualify as prior art at the time of filing, are neither expressly nor impliedly admitted as prior art against the present disclosure.

With the perpetuation of wireless and software technologies, social and commercial activities are increasingly taking place within cloud-based digital networking platforms. Networks will grow and thrive based upon their ability to foster connectivity between user-members, utilize network effects and viral effects to add value to the network and grow its membership, develop advanced financial payment architectures to reward user-members for their network activities, and provide different relationship layers based on user-member referrals and commercial activities.

There is a great need to develop ever more sophisticated networking platforms that can enhance the connectivity and activity of its online communities. Increasing the connectivity between online-community user-members creates greater opportunities for social networking and commerce between user-members, thereby enhancing the overall activity and engagement within the online-community on networking platforms. With existing networking platforms, online-community members experience limitations in finding and creating connections with other user-members to the fullest ability capable within the networking platform. While online-community members have some ability through offline real-world experiences to find and connect with other user-members through the networking platform, user-members are limited to the software tools available on the network to locate and generate new connections. Networking platforms that are equipped with advanced tools to identify commonalities between online-community user-members and facilitate new connections through the platform have enormous potential and utility for building communities of online-members and facilitating interactions and commerce between them. As such, there is a great need for development in the field of data analytics and social-commercial networking software for generative connectivity where connections between online-members are identified and offered to online-community members to enhance their engagement across the cloud-based digital networking platform increasing the value of the network and value to each user-member.

Understanding and capitalizing on network effects and viral effects is highly valuable for developing advanced social and commercial cloud-based networks with generative connectivity. The core principle of network effects is that every user-member who joins a network adds value to every other user-member of that network. This added value of each user-member to every other user-member creates stability within the network deterring user-members from leaving the network. The benefits that each user-member brings to each other within the network create stickiness within the network and foster strong user retention adding value to the network and each user-member. Network effects focus on keeping and retaining user-members. This ability to retain user-members through network effects provides defensibility against competition from other networks. Network effects focus on the value that grows from an increase of user-members with the network. Marketplaces and networks thrive when more user-members are present to interact with each other. For thousands of years, larger marketplaces with more sellers and more buyers have facilitated greater economic attention, greater foot traffic, larger consumer attention, a greater volume of commerce, and greater selections for consumers benefiting both sellers and consumers. Pre-internet telephone networks grew and remained dominant as users joined these networks and had the ability to interact with other members bringing increased value to each user-member with the ability to contact ever-growing numbers of user-members. The larger a network becomes, the more valuable it becomes for new users to join that network, thereby outcompeting potential rival networks. Software operating systems have experienced widespread adoption through platform network effects. When an operating system gained users, a corresponding increase occurred in the number of software providers who made software for that operating system to gain access to the market of users. As more software was created for the particular operating system, more users wanted to purchase that operating system to gain access to the software. This increase in users of the operating system and the providers of software that ran on the operating system brought enormous value to the operating system and long-term retention of users and software providers. Viral effects occur when a network gains new user-members because of promotions from existing user-members. While viral effects focus on growth in the number of user-members, network effects focus on the growth in value user-members bring to each other and the network as a whole through being a part of the network as new member-users join the network. In terms of impact on the network, network effects are value-oriented, while viral effects are growth-oriented. Network effects are long-lasting providing long-term stability and defensibility competitively to the network, while viral effects are short-lived surges that bring short-term attention and short-term value to the network.

Existing social and commercial networks generally incorporate some kind of payment or financial reward system. These existing payment and financial reward systems are generally based on one-off awards based on a single activity, which is typically from either joining the network or referring a new user-member to the network. While these payment and financial reward systems encourage certain user-member activities, the fact that they are centered around single one-time payments results in short-term effects on user-member engagement with the network and other user-members or potential user-members. Existing social and commercial networks are greatly falling short of their full potential by offering payment and financial reward systems that result in short-term effects. It is greatly desired to create new and advanced payment and financial architectures for user-member activity and engagement on networks that incentivize and reward long-term recurring engagement and activity on the social network.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

In an embodiment, the disclosure describes technology for an advanced social-commercial online digital network of user-members. The present specification discloses a technology for connection-hunting software that generates connectivity between user-members of the network through rule-based data analytics or artificial intelligence. The present specification discloses a network with technologies for creating value for the network and user-members through various combinations and synergy of network effects and viral effects. The present specification also discloses a technology for financial payment architectures for user-members based upon the recurring value of their sub-network within the cloud-based network to incentivize and reward long-term network value-building engagement. The present specification also discloses a technology for a network having separate network logical layers for user-member network referrals and commercial activities to facilitate the precision of financial payment rewards and user-member engagement.

The multi-layered social-commercial network disclosed within this specification utilizes network effects and viral effects for generative connectivity within the network, expanding the network to new user-members, increasing value to user-members, and growing commerce within the network. One layer of the network is a social referral network layer where user-members are logically linked together based upon which member-user referred the others into the network, thereby forming a user-member network having the structure of a Merkle tree. Another layer of the network is a commercial layer that may be formed of innumerable separate layers for different products, services, and subscriptions. A payment architecture within the network provides recurring financial rewards to online-community user-members based on the recurring network engagement, activity, and commerce of online user-members within each user-member's individual network. A social network hunter utilizes a data analytics rule base or artificial intelligence for generative connectivity between user-members of the network. The social network hunter mines social networking data to identify and generate new connections between existing user-members of the network in order to increase engagement and connectivity between members, thereby increasing network effects on the network for user-members adding value to the network and each user-member.

The financial payment architecture of the network disclosed in the present specification incentivizes and rewards long-term activity and engagement with the network and other user-members on the network. The common practice within prior-art social networks is centered on one-time payments for a one-off activity, which is typically from joining the network or referring a new individual to join the network as a user-member. These single one-time payments of prior art networks are narrowly focused on short-term activity and do not incentivize and reward long-term engagement with the network. The financial payment architecture disclosed in the present specification is fundamentally different in that it is based on the ongoing long-term engagement and activity of user-members and the sub-networks of each user-member logically linked by referrals or commerce. Each user-member on the network has their own sub-network that spawns from them based upon referrals of new user-members or commerce. New user-members join the network by referring other individuals to join the user-member network. These referrals logically link user-members together in a relationship structure having the form of a Merkle tree. Each user member may also offer products, services, or subscriptions to other user-members forming commercial relationship structures having the form of a Merkle tree. Each user-member is measured based on their total engagement and activity on the network. This engagement and activity includes all forms of digital communications, digital transactions, and digital activities on the network such as referring new individuals to join the network, offering goods to sell on the network, purchasing goods, services, or subscriptions from another user-member on the network, offering media for viewing on the network, viewing media on the network, advertising on the network, viewing advertising on the network, provides links for other user-members to click through, clicking through links provided by other user members, spending time on the network, generating content or viewing content on the network, or otherwise engaging in any other activity on the network. A data analytics engine gathers data on each user-member to qualify and quantify the types and amount of engagement that they have with the network and other user-members and the network system. Each user-member receives an impact score that quantifies their value to the network. This impact score is the sum of the individual user-members commercial and referral activity on the network and the commercial and referral activity of all user-members within individual user-members sub-network logically linked to them by Merkle tree relationship structures. The impact score for each user-member based on their individual activity and all activity within their sub-network is calculated on a periodic recurring basis. The impact score is then used to determine a financial or other reward that is transacted to each user-member. Financial rewards may include financial payments, cryptocurrency, network payment credits useable for transactions on the network, gift cards, NFTs, or any other form of payment. Other rewards to user-members may include enhanced access to network services that can increase the size and value of each user-member's sub-network through advertisements, communications, access to data analytics tools, or other network services. The impact score is calculated on a recurring periodic basis indefinitely so that user-members may receive an ongoing recurring payment based upon their individual and their sub-network's total activity. The higher a user-member's impact score, the greater their financial reward. As such, the impact score and recurring periodic financial payments based on them incentivize and reward ongoing long-term engagement and activity on the network, which is a fundamental leap above the single one-time payments known in the prior art. In essence, this financial payment architecture disclosed in this specification is geared towards incentivizing and rewarding the network effects each user-member conveys through their activity and engagement on the network as well as the viral effects they provide through new membership. In contrast, the prior art systems incentivize just viral effects only through one-time payments for joining a network or referring others to join the network.

The impact score disclosed in the present specification is used to measure each user-member's engagement on the network. Some user-members will prove exceptionally active on the network. Other user-members may engage minimally or not at all with the network at various times. Each user-member's impact score may be judged against various preset thresholds for rewards. For example, in a preferred embodiment, there may exist a minimum threshold that user-member's individual impact score must exceed in order to receive any financial or other reward as a recurring payment. If an individual user-member's impact score falls below this minimum impact score, they may not qualify for any payment for that payment period. However, once their impact score exceeds the minimum threshold for any time period, they will receive a payment for that time period. There may exist other higher thresholds that entitle user-members to increased payment or rewards for increased engagement in the network. These thresholds can ensure that dormant or fake user-members who have “zombie” accounts do not participate in financial rewards intended for real and active user-members engaging with the network.

The social-commercial network disclosed in the present specification is a multi-layered network that includes different logical layers for connections based on referral relationships of user-members to each other and separate layers for commercial activities. In one embodiment, each good, service, subscription, or other commercial offering has its transactions logically linked on a separate commercial layer of the network. Other commercial offerings may include commercial sales of commodities, securities, currency, digital currency, crypto coins, Non-Fungible Tokens (NFTs), or other commercial offerings. A group of original user-members found the network at its launch. Each of these original-user members refers other individuals to the network. The network records the relationships of user-members within the network based upon who referred who to the network and records these relationships in Merkle tree data structures. Each of these original user-members forms a root node within the Merkle tree referral network. The most recent user-members that have not referred any user-members to the network form leaf nodes within the Merkle tree referral network. User-members referred to the network after the original user-members who were referred before the most recent user-members form intermediate nodes within the Merkle tree referral network. While there is this Merkle tree referral network structure that permanently records the referral relationships of user-members with respect to each other, any user-member may offer a product, service, subscription, or other commercial activity for sale on the network and in doing so, transform themselves into a root node of a new commercial network layer for that commercial activity where all other user-members are consumers forming intermediate nodes or leaf nodes with respect to that commercial activity. As such, each user-member is logically related to other user-members on different layers based upon their referral relationships and their commercial activities as a seller or buyer in commercial transactions. As discussed above with respect to the financial payment architecture, the impact score is calculated using the Merkle tree relationships between user-members based on their referral activities and commercial activities of the individual user-members and all user-members linked to them through their sub-network. The referral network connections recorded in the Merkle tree last for the lifetime of user-member's relationship on the network. As such, user-members are paid for the lifetime membership and engagement of user-members referred to the network by them.

The entire social-commercial network is powered by a data analytics engine that gathers data and information on the network, each individual user-member, and the sub-networks of each user-member attributable to them. This gathered data is used to foster greater engagement of user-members, commerce between user-members, and all other forms of communication and transactions between user-members. Gathered data on the network and its user-members may be used to generate information and analytics on each user-member and groups of user-members that can support advertising, commerce, and other financial activities available to commercial entities. The social-commercial network may earn financial income through transacting data on the network, user-members, and groups of user-members to commercial entities. The social-commercial network includes a variety of tools with which to engage user-members on an individual level or in groups. These tools include media, advertisements, links, direct electronic messages, emails, text messages, SMS messages, instant messages, videos, coupons, financial payments, and rewards, offers for support with network services, videos, images, electronic communications, overlap connections recommendations with a social network connection hunter, or product recommendations. The network may utilize the gathered data to make decisions as to how to engage with user-members through the use of these network tools in order to drive desired behaviors from user-members and the network as a whole. These desired behaviors may include growth of the network, growth of connections within the network, or growth of engagement of user-members within the network. In short, the network utilizes these tools to drive network effects and viral effects on the network. The network may utilize a data analytics tool with a rule-based monitored by an administrator to make decisions on which desired behaviors to promote and which tools to use in what manner to promote those desired behaviors. Alternatively, the network may utilize artificial intelligence to make decisions as to which tools to use in what manner to promote desired behaviors by user-members on the network.

The social-commercial network disclosed in the present specification includes a simulator in which the data analytics engine can simulate the behavior of user-members on the network when the network engages with them using the network tools discussed above. The simulator can inform an administrator or artificial intelligence on the likely outcome of using network tools to engage with user-members. The simulator can run any permutation in the duration, quantity, or combination of tools in combination with user-member behaviors to determine a predictive outcome on the use of those tools. The simulator can predict network effects and viral effects through the use of gathered data on existing behaviors of the user-members and the network and predictive algorithms. These predictions can then be measured against actual data gathered on the real behavior of the individual user-members and the network to help the simulator better refine its predictive algorithms to more accurately simulate the network. Based upon the outcomes of the various simulations aimed to stimulate network or viral effects, such as increasing internal connections, increasing commerce on the network, or increasing the addition of new members, the network can then be actually engaged using the tools to pursue the predicted outcomes.

While various businesses are built upon either network effects or viral effects, the present specification discloses an online social-commercial network that provides generative connectivity through a combination of network effects and viral effects to increase the growth and value of the network for the user-members and network as a whole. While viral effects are short-lived, utilization of data analytics and artificial intelligence can foster retention and conversion of the viral effects into enhanced network effects. Further, the utilization of data analytics and artificial intelligence can foster enhanced viral effects based on the network effects occurring within the network. As such, recurring pulses of viral effects can greatly grow and magnify the network effects and value that the network brings to each user-member. The network disclosed in the present specification utilizes data analytics on the network and its user-members to quantify and qualify the network effects on the network for user-members. Using this data, the data analytics engine can predict which tools to use or connections to generate in order to enhance the network effects and viral effects.

The present specification discloses a non-transitory computer-readable storage medium containing instructions for a method of determining a periodic payment to users of a social network based on a combination of network effects and viral effects attributable to that member. Users of a cloud-based social network are associated into a Merkle tree structure based on an order of membership referrals as to which user referred which to the cloud-based social network. An amount of digital engagement that a first user has with the cloud-based social network is quantified through an individual impact score. All users that were referred to the cloud-based social network by the first user are attributed into the first user's sub-network. An amount of digital engagement for all users within the first user's sub-network has with the cloud-based social network is quantified through a sub-network impact score. A recurring electronic payment is made to the first user on a periodic basis utilizing the individual impact score and the sub-network impact score. The digital engagement includes hyperlink click-throughs, viewing digital media, viewing digital advertisements, viewing time spent on the cloud-based social network, posting of digital material on the cloud-based social network, and commercial activity on the cloud-based social network. The individual impact score and sub-network impact score are recalculated for the first user and the first user's sub-network on a periodic basis. The digital engagement is a measure of the network effects attributable to the first user and the first user's sub-network. The inclusion of the first-user's sub-network is a measure of the viral effects attributable to the first user. A data analytics engine in communication with the cloud-based social network acquires data on the first user and the first user's sub-network to determine the digital engagement for the first user and the first user's sub-network. The data analytics engine generates the individual impact score and sub-network impact score utilizing artificial intelligence or machine learning. The present specification also discloses a non-transitory computer-readable storage medium containing instructions for a multilayered social network utilizing a combination of network effects and viral effects for growth of the multilayered social network. Network effects are utilized to drive users of a cloud-based social network to add new users to the cloud-based social network. Digital information is captured on all users of the cloud-based social network. A data analytics engine is used to generate viral effects within the cloud-based social network to increase commerce within the cloud-based social network. Digital information is captured on the viral effects to generate new network effects for existing users of the cloud-based social network for adding additional new users to the cloud-based social network. A referral network layer is where users are linked together into a Merkle tree based upon the user that referred them to the cloud-based social network. A commercial network layer is where users are dynamically linked to other users based upon commercial activity without regard to which user referred them to the cloud-based social network. An artificially intelligent social network connection hunter generates internal connections between existing users of the cloud-based social network to support viral effects within the cloud-based social network. The artificially intelligent social network connection hunter generates internal connections based on data gathered from the existing users of the cloud-based social network. Aa data analytics payment engine monitors cloud-based social networking activity of each user within the cloud-based social network. The data analytics payment engine assigns an impact score to each individual user based upon their total engagement activity online with the cloud-based social network. The data analytics payment engine distributes financial payments to users that have an impact score above a minimum threshold. The data analytics payment engine does not distribute financial payments to users that have an impact score below a minimum threshold. The impact score includes the cloud-based social networking activity of other users that can trace their referral back to the user receiving an impact score such that the impact score reflects the activities of the user in question and all users within their social network. A cloud-based social network in the artificial intelligence engine simulates behavior of users within the cloud-based social network in response to application of stimulus applied by the cloud-based social network to one or more users. The present specification also discloses a non-transitory computer-readable storage medium containing instructions for a method of selecting nodes within a digital social network for participation with financial payment distributions based upon individual impact scores for each node. A digital network captures activity data for each node of a cloud-based digital social network utilizing a data analytics engine. An individual impact score is assigned for each node based on the digital network activity of that node. Financial payments are then distributed to each node based on their impact score. The digital network activity includes electronic communications between nodes, electronic transactions between nodes, electronic purchases between nodes, offering for sale products or services to other nodes, viewing electronic media from other nodes, expanding the size of the digital social network by adding new users as nodes of the digital social network, and any other form of electronic network activity between nodes of the digital social network. Each type of digital network activity is assigned a score. Each score varies based upon a level of activity for a particular digital network activity. The individual impact score is a weighted summation of the assigned scores for the various types of digital network activities engaged in by each individual node. Nodes that fail to have an impact score that rises above a minimum threshold are excluded from receiving a financial payment distribution. A node that does not have an impact score that rises above a minimum threshold and is excluded from a financial payment distribution for a first payment period may receive a financial payment distribution for a second payment period when the impact score for that node rises above the minimum threshold. The present specification also discloses a non-transitory computer-readable storage medium containing instructions for generative connectivity between nodes of a digital social network through artificial intelligence. Users of a cloud-based social network are associated into a Merkle tree structure based on an order of membership referrals as to which user referred which to the cloud-based social network. The Merkle tree structure forms a first layer of the cloud-based social network. Commercial activities of the users are tracked on the cloud-based network. The commercial activities form a second layer of the cloud-based social network. Data on the user activities is acquired with artificial intelligence to quantify network effects based on digital engagement of the users with the could-based social network. Information on the network effects is utilized to generate new user connections based on viral effects. Data on the user activities is acquired with the artificial intelligence to quantify viral effects based on digital engagement of the users with the cloud-based social network. Information on the viral effects is utilized to generate new user connections based on network effects. The network effects include electronic communications between nodes, electronic transactions between nodes, electronic purchases between nodes, offering for sale products or services to other nodes, viewing electronic media from other nodes, and any other form of electronic network activity between nodes of the digital social network. The viral effects include expanding the size of the digital social network by adding new users as nodes of the digital social network. An analytics engine utilizes a network tool kit to generate new user connections based on viral effects, wherein the analytics engine utilizes a network tool kit to generate new user connections based on network effects. A network tool kit includes advertisements, videos, media, images, electronic messaging, coupons, financial rewards, product recommendations, or other form of user digital engagement. Further aspects of the invention will become apparent as the following description proceeds and the features of novelty, which characterize this invention, are pointed out with particularity in the claims annexed to and forming a part of this specification.

### BRIEF DESCRIPTION OF THE DRAWINGS

The novel features that are considered characteristic of the invention are set forth with particularity in the appended claims. The invention itself; however, both as to its structure and operation together with the additional objects and advantages thereof are best understood through the following description of one or more embodiments of the present invention when read in conjunction with the accompanying drawings. The components in the figures are not necessarily to scale, emphasis instead being placed upon illustrating the principles of the invention. In the figures, like reference numerals designate corresponding parts throughout the different views, wherein:

FIG. 1 illustrates a schematic block diagram of a multi-layered social network that grows connections through generative connectivity based on viral effects and network effects along with its supportive hardware network architecture;

FIG. 2 illustrates that the multi-layered social network is formed of a referral network layer based on viral effects and a multitude of commercial network layers based on network effects;

FIG. 3 illustrates the referral network layer having an architecture in the form of a Merkle tree that grows on viral effects where user-members of the network refer new user-members to join the network;

FIG. 4 illustrates a commercial network layer having an architecture in the form of a web of interconnected nodes where users of the network conduct commerce with each other that is based on network effects;

FIG. 5 diagrams a user-member of the multi-layered social-commercial network and that individual's relationships on the multi-layered social-commercial network through the referral network layer based on viral effects and the commercial network layer based on network effects;

FIG. 6 illustrates the data analytics engine and a schematic view of its processing of network information on viral effects, network effects, and other social-commercial network information on the referral network layer, the commercial network layer, and the remainder of the multi-layered social-commercial network;

FIG. 7 illustrates a flowchart depicting a process for paying user-members based upon their individual impact score developed from their individual activity on the multi-layered social-commercial network as well as the activity of their connections within their sub-network on the multi-layered social-commercial network;

FIG. 8 illustrates the calculation of a user-member's total impact score based upon a summation of that user-member's individual impact score and the impact score based on that user-member's sub-network;

FIG. 9 illustrates the calculation of a user-member's commercial impact score that is based upon all of that user-member's commercial activities;

FIG. 10 illustrates the calculation of a user-member's total impact score which is based on the individual impact score for that user-member and the impact score for that user-member's sub-network;

FIG. 11 illustrates an exemplary calculation of the royalty payment to a user-member based on their total impact score;

FIG. 12 illustrates a flowchart depicting a process for computing an individual impact score for a user-member;

FIG. 13 illustrates a flowchart depicting a process for computing a total impact score for a user-member based upon their individual score and the impact score of their sub-network;

FIG. 14 illustrates a schematic flow diagram of how the data analytics engine utilizes a social-commercial network tool kit in combination with a network connection hunter to stimulate and grow the multi-layered social-commercial network through new user-members, new connections between user-members, and increasing network commerce;

FIG. 15 illustrates a schematic flow diagram depicting how the data analytics engine gathers data from the multi-layered social-commercial network and uses that data with the simulator to determine how use of the network tool kit can stimulate activity and growth in the multi-layered social-commercial network through new user-members, new internal connections, and commercial growth, which is used to guide actions by the multi-layered social-commercial network with interacting with user-members;

FIG. 16 illustrates a flowchart depicting a process for simulating the behavior of the multi-layered social-commercial network with a simulator on the data analytics engine to project user growth, growth of internal overall connections, and growth of network commerce based on application of the network tool kit;

FIG. 17 illustrates a flowchart depicting a process for programming the data analytics engine to achieve desired goals for the multi-layered social-commercial network such as new user growth, growth of internal connections, or growth of network commerce;

FIG. 18 illustrates a schematic flow diagram showing the data analytics engine utilizing the tool kit to engage with users of the multi-layered social-commercial network to generate user activity in conformance with the programmed goals for the multi-layered social-commercial network as simulated by the data analytics engine;

FIG. 19 illustrates a flowchart depicting a process for the analytics engine using the network tool kit to implement engagement actions with the social network;

FIG. 20 illustrates a schematic flow diagram depicting how the data analytics engine forms a closed loop control system for the multi-layered social-commercial network;

FIG. 21 illustrates a flowchart depicting a process for generating overlap connections with an artificially intelligent social network hunter;

FIG. 22 illustrates a schematic diagram of a payment engine with the multi-layered social-commercial network interacting and bi-directionally communicating across the cloud with product stores, subscription providers, and user applications through Software Development Kits (SDKs) and Application Programming Interfaces (APIs) allowing product stores, subscription providers, and user-members of the multi-layered social-commercial network to engage with each other for commercial activities;

FIG. 23 illustrates a schematic diagram of the multi-layered social-commercial network bi-directionally communicating with applications allowing user users to engage with the multi-layered social network from mobile devices and computer workstations such as desktop and laptop computers;

FIG. 24 illustrates a schematic drawing of utilizing a data analytics engine in the multi-layered social-commercial network to gauge the impact score of individual user-members within the multi-layered social-commercial network to determine when to collapse social network structures to remove dormant user-member nodes from payment calculations based on whether individual user-member nodes maintain a minimum impact score above a preset threshold;

FIG. 25 illustrates a flowchart depicting a process for collapsing social network structures to remove dormant user nodes for payment calculations based on whether individual user nodes maintain a minimum impact score above a present threshold;

FIG. 26 illustrates a block diagram of an analytics engine on the multi-layered social network and its interconnected administrator interface and artificial intelligence unit;

FIG. 27 illustrates a schematic of a process for generative connectivity creation with a data analytics engine using viral effects and network effects to mutually enhance each other, thereby growing the social-commercial network size and value by reinforcing user-member engagement;

FIG. 28 illustrates a flowchart depicting a process for generative viral connection creation based on commercial offerings and network effects within the social-commercial network; and

FIG. 29 illustrates a flowchart depicting a process for generative network connection creation based on viral effects within the social-commercial network.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meaning have otherwise been set forth herein.

### DETAILED DESCRIPTION

The present invention now will be described more fully hereinafter with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

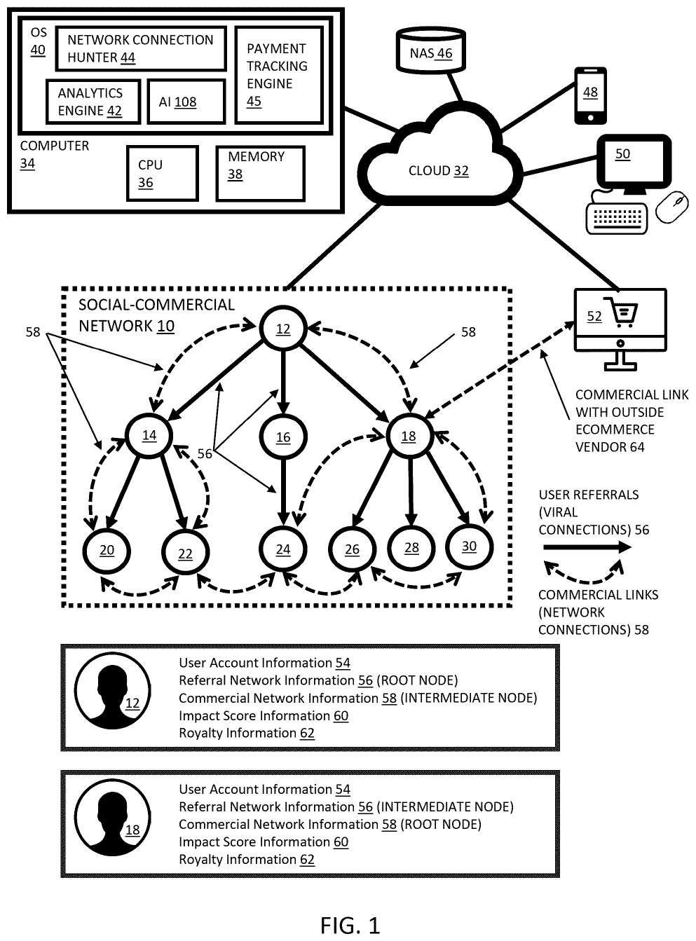

FIG. 1 illustrates a schematic block diagram of a multi-layered social-commercial network 10 that grows connections through generative connectivity based on viral effects and network effects along with its supportive hardware network architecture. The multi-layered social-commercial network 10 is functioning on a cloud 32 that exists on the internet. Cloud 32 is formed of data-farms, servers, computing networks, communications networks, and other networking hardware needed to form a cloud that can support big-data computing for social-commercial network 10. Cloud 32 is coupled to a computer 34 that includes a Central Processing Unit CPU 36 and memory 38. An operating system OS 40 runs on computer 40. A variety of software applications that support social-commercial network 10 runs on OS 40. These software applications include a data analytics engine 42 that gathers data on the social-commercial network 10 and all user-members within the network. Data analytics engine 42 also performs statistical and data analysis on the gathered data to inform an administrator or artificial intelligence on the status and behavior of network 10 and its user-members. Also operating on OS 40 is a social network hunter 44 that identifies and facilitates new internal connections between existing members of the social-commercial network. Generating new connections between user-members of social-network 10 increases the network effects of network 10 for each user-member. The more connections there are between user-members, the greater the value of the network 10 is to each user-member. The social network hunter 10 may be based upon an administrator operating data analytics engine 42. Alternatively, social network hunter 10 may be powered by artificial intelligence that examines data gathered by data analytics engine 42 to identify and generate new connections between user-members of network 10. Also operating on OS 40 is a payment tracking engine 45. Each user-member of social-commercial network 10 receives a periodic recurring payment based upon their own activity on network 10 and the combined commercial and referral activity of each user-member within that user-members sub-network. The activity of the user-member and their sub-network is quantified in an impact score generated by the analytics engine that informs the payment tracking engine 45 on what payment should be made to each user-member for each payment period. Payments may be financial payments or conveyance of alternative items or services of value. Financial payments may include electronic transfers of currency, digital currency, crypto coins, NFTs, coupons, gift cards, in-network credits, or other forms of financial payment. Alternative items or services of value may include free in-network advertising, use of the social network hunter 44 to grow their own sub-network, ability to send invitations to potentially new user-members, or other in-network services. Computer 34 has access to Network Attached Storage NAS 46 in order to store data generated by network 10 for gathering an analysis by data analytics engine 42. A mobile application allowing user-members to interact with social network 10 is running on the operating system of mobile device 48, which is typically a cell phone. A software application allowing user-members to interact with social network 10 is running on the operating system of computer 50 shown with a monitor, keyboard and mouse. Computer 50 is typically a consumer desktop computer or laptop computer. It is contemplated that innumerable numbers of mobile devices 48 and computing devices 50 may interact with social-commercial network 10 running on cloud 32 through the internet. The links connecting cloud 32 with network 10, computer, 34, NAS 46, mobile device 48, and computer 50 support bi-directional communication. Network 10 is also in bidirectional communication with commercial e-commerce vendor 52 that is shown running on a computer. The bidirectional link between network 10 and commercial e-commerce vendor 52 is a commercial link 64 that allows for commercial transactions between the commercial e-commerce vendor 52 and user-members of network 10, which in this case is user-member 18. Network 10 shows a plurality of user-members 12, 14, 16, 18, 20, 22, 24, 26, 28, and 30. User-members 12, 14, 16, 18, 20, 22, 24, 26, 28, and 30 are connected with each other through various logical relationships on different layers of network 10. Network 10 includes a referral network layer where all user-members are logically linked together into a Merkle tree based upon which existing user-member referred downstream user-members to the referral network shown in solid lines 56. This addition of new user-members to the network 10 and the growth of the network 10 is a viral effect. In this exemplary figure, user 12 is the original user-member and is the root node of the referral Merkle tree relations structure shown by solid lines 56. User 12 referred user-members 14, 16, and 18 to network 10. User-member 14 referred user-members 20 and 22 to network 10. User-member 16 referred user-member 24 to network 10. User-member 18 referred user-members 26, 28, and 30 to network 10. Each person, business, corporation, association, club, or other entity that joins network 10 is referred to as a user-member as they use network 10 and are also a member of network 10. The referral relations between user-members 12, 14, 16, 18, 20, 22, 24, 26, 28, and 30 as to who referred who are recorded in a referral network Merkle tree identified by referral connections 56. In this example, user-member 12 has user-members 14, 16, 18, 20, 22, 24, 26, 28, and 30 within its sub-network. User-member 14 has user-members 20 and 22 within its sub-network. User-members 12, 16, 18, 24, 26, 28, and 30 are not in the sub-network of user-member 14. User-member 16 has user-member 24 within its sub-network. User-member 18 has user-members 26, 28, and 30 within its sub-network. These user-member relationships shown by line 56 last for the network lifetime of the user-members. These user-member relationships shown by lines 56 forming the Merkle tree are used to compute an impact score for each user member to determine a financial or other rewards payment made on a periodic recurring basis to each user-member. Each user-member may offer for sale goods, services, subscriptions, or other items for commercial transactions, bartering, or other form of payment. Each user-member may simultaneously be a consumer of these goods, services, subscriptions, or other items. The relationships generated by these commercial transactions between user-members are shown by commercial links 58, which are an example of a network effect. The presence of more user-members who are sellers and more user-members who are buyers leads to the enhanced value of network 10 to each user-member, which is the core principle of network effects. In this example, user-member 19 is the root node for selling a particular product, service, or subscription offered by commercial e-commerce vendor 54 through commercial link 64. Commercial links 58 are shown as bidirectional to represent the bidirectional exchange of payments and commercial items between buyers and sellers who are both user-members. In this example, user-members 24, 30, and 12 are the first level of buyers from user 18 for a commercial item that user-member 18 acquired from vendor 52. User-member 14 is engaged with commerce from user-member 12 and in turn engages in commerce with user-members 20 and 22. User-members 20 and 22 are shown in commerce with each other, along with users 22 and 24, 24, and 26, and 26 and 30. These complex commercial relationships can represent the bulk purchase of items from user-member 18 and subsequent resale of items to other user-members. The addition of more commercial items for sale and the addition of more buyers of these commercial items is a network effect that enhances the value of network 10 to all user-members increasing the defensibility and longevity of network 10. Two exemplary user-member profiles are shown at the bottom of FIG. 1. User-member 12 has a profile that is shown to have user account information 54, the referral network information 56 (which in this case shows user-member 12 is the root-node of the referral network Merkle tree), the commercial network information 58 (which in this case shows user-member 12 is an intermediate node of the commercial network layer), the impact score information 60 of user-member 12 that signifies the network engagement of user-member 12 and all user-members within the sub-network of user-member 12, which in this case, are user-members 14, 16, 18, 20, 22, 24, 26, 28, and 30. The information associated with user-member 12 also includes royalty information 62 which is the financial payment or reward information provided to user 12 on a periodic recurring basis based upon their impact score. User-member 18 has a profile that is shown to have user account information 54, referral network information 56 (which in this case shows user-member 18 is an intermediate node of the referral network Merkle tree), commercial network information 58 (which in this case shows user-member 18 is a root-node of the commercial network layer, the impact score information 60 of user-member 18 that signifies the network engagement of user-member 17 and all user-members within the sub-network of user-member 18, which in this case, are user-members 26, 28, and 30. The information associated with user-member 18 also includes royalty information 62 which is the financial payment or reward information provided to user 18 on a periodic recurring basis based upon their impact score. Each and every user-member has the set of user-member information shown above for user-members 12 and 18.

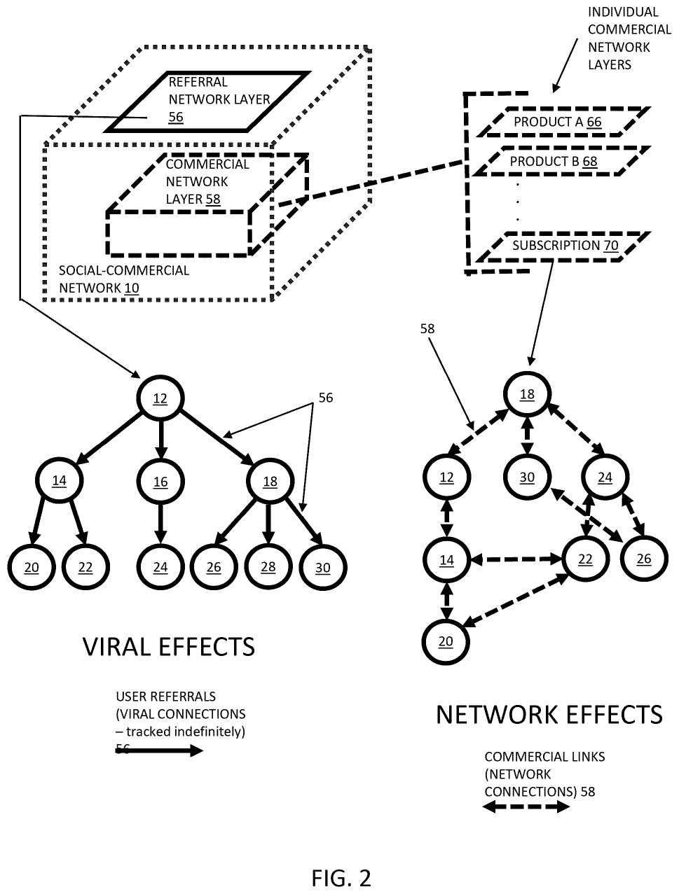

FIG. 2 illustrates that the multi-layered social-commercial network 10 is formed of a referral network layer 56 based on viral effects and a multitude of commercial network layers 58 based on network effects. Referral network layer 56 stores the relationship information based on viral effects of which user-members referred other user-members in which order. All information of the referrals between user-members is stored within the Merkle tree forming the storage architecture of the sequence and order in which user-members joined network 10 through referrals from other user-members. In this example, the user-members are 12, 14, 16, 18, 20, 22, 24, 26, 28, and 30. User-member 12 is the original user-member and functions as the root node in this exemplary referral network Merkle tree membership data record. User-members 14, 16, and 18 are intermediate nodes in this exemplary Merkle tree membership data record. User-members 20, 22, 24, 26, 28, and 30 are leaf nodes within this exemplary referral network Merkle tree membership data record. User-members 14, 16, 18, 20, 22, 24, 26, 28, and 30 are downstream of user-member 12 in the exemplary Merkle tree membership data record with regard to the referral relationship history. User-members 20, 22, 24, 26, 28, and 30 are downstream of user-members 12, 14, 16, and 18 with regard to the referral relationship history. Conversely, user-member 12 is upstream of user-members 14, 16, 18, 20, 22, 24, 26, 28, and 30 are in the exemplary Merkle tree membership data record with regard to the referral relationship history. Likewise, user-members 14, 16, and 18 are upstream of user-members 20, 22, 24, 26, 28, and 30 are in the exemplary Merkle tree membership data record with regard to the referral relationship history. The Merkle tree membership data record represents user referrals by arrow 56. Arrow 56 represents which user-member referred other user-members into the network. Here, user-member 12 referred user-members 14, 16, and 18 into the network. User-member 14 referred user-members 20 and 22 into the network. User-member 14 referred user-member 24 into the network. User-member 18 referred user-members 26, 28, and 30 into the network. In the Merkle tree membership data record, all user-members that act as a root node for downstream members have those downstream members within their sub-network. In this case, user-member 12 has user-members 14, 16, 18, 20, 22, 24, 26, 28, and 30 within its sub-network as user-member 12 is a root node for these other user-members. User-member 14 is a root node for user-members 20 and 22 and has user-members 20 and 22 within its sub-network. User-member 16 is the root node for user-member 24 and has user-member 24 in its sub-network. User-member 18 is the root node for user-members 26, 28, and 30 and has user-members 26, 28, and 30 within its sub-network. User-members 20, 22, 24, 26, 28, and 30 do not have any user-members within their sub-networks in this example. The Merkle tree membership record records relationships for the entire lifetime that user-members are a part of the network. When user-members cancel their account, their data node remains within the Merkle tree to preserve the various relationship structures 56 within the Merkle tree, but has all other membership information removed from the node and Merkle tree. The referral network layer 56 tracks the viral effects within network 10. The network effects of network 10 are recorded within commercial network layer 58. Commercial network layer 58 records the commercial engagement and activities of user-members across network 10. These commercial activities are contemplated to include any commercial activity such as selling and buying goods and services, subscriptions, NFTs, currency, digital currency, cryptocurrency, securities, commodities, or any other commercial item. Layer 58 may also record other activities such as the formation of social clubs, political organizations, sports teams, or any other form of human engagement or organization. It is contemplated that layer 58 is formed of a plurality of layers for each separate goods and services, subscriptions, NFTs, currency, digital currency, cryptocurrency, securities, commodities, or any other commercial item, or form of human organization. In this case, layer 66 is for product A, layer 68 is for product B, and layer 70 is for subscription 70. The data record for subscription 70 is shown in the network diagram below where user-member nodes 18, 12, 30, 24, 14, 12, 26, and 20 are joined together by bi-directional commercial links 58, which are a form of network effects. Here, user-member node 18 is the original seller of subscription 70. The other user-members 12, 30 and 24 engage in commerce directly with node 18, which is shown by bi-directional arrows 58 to represent the bi-directional nature of commerce where sellers provide goods and buyers provide payment. Commercial links 58 are not based solely on purchases but can represent any form of engagement. For example, the commercial engagement can include showing advertisements, clicking on advertisements, providing commercial referrals, clicking on product hyperlinks, forwarding hyperlinks. As such, these commercial links can represent complex commercial activities and engagement between user-members. For example, user-member 30 may view an advertisement from user-member 18 and repost it on their network. User member 26 may then view the advertisement from the post of user-member 18 and purchase it by clicking on a link posted by user-member 18, which is represented by link 58. User-member 26 may have also viewed the same subscription in an advertisement in a post from user-member 24, but did not elect to buy it through a link provided by user-member 24. Commercial activities arise from a sum total of all engagement between sellers, buyers, and intermediaries who provide posts, reviews, links, advertisements, coupons, or other engagement regarding a commercial item.

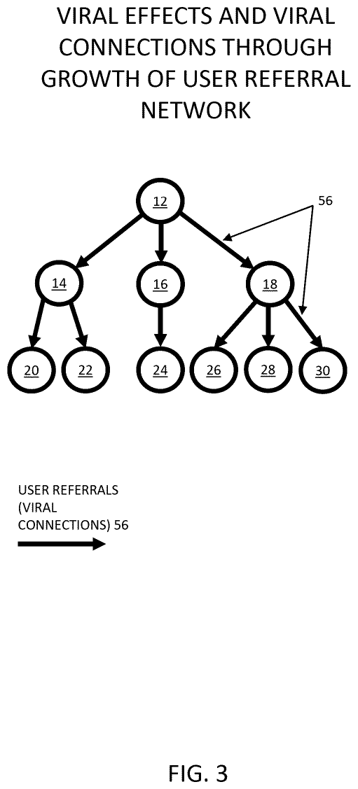

FIG. 3 illustrates the referral network layer having an architecture in the form of a Merkle tree that grows on viral effects where user-members 12, 14, 16, 18, 20, 22, 24, 26, 28, and 30 of the network 10 refer new user-members to join the network 10. Viral effects are about adding new user-members to network 10, which are recorded into the Merkle tree membership data record shown in FIG. 3 for the lifetime of network 10. The Merkle tree membership data record shown in FIG. 3 is utilized as one component to value the impact of each user-member within network 10. Some user-members will be hyper-impactful and refer vast numbers of real user-members to network 10 who are active on user 10 and engage in a large value of commerce. The Merkle tree membership data record shown in FIG. 3 allows network 10 to attribute the value and credit to which user-members refer hyper-impactful users to network 10 as well as recognize the total commercial activities and network effects of user-members within each user-members sub-network. To identify, attribute, and value the commercial activities and network effects of sub-networks within network 10, it is necessary to have a historical record of the formation of sub-networks in which user-members referred other user-members in what order. Through having the Merkle tree membership data record shown in FIG. 3, it is possible to identify and track these sub-networks and attribute their value to the user-members who created them through their user-member referrals. Network 10 provides financial or other rewards to user-members based on their individual commercial activities and all other network engagement, but also the commercial activities and all other network engagement of all user-members within each user-member's sub-network. This valuation technique of rewarding user-members for the value of their sub-network gives each user-member as massive long-term incentive to participate in and engage with network 10. At its core, this valuation technique of rewarding user-members for the value of their sub-network gives each user-member a stakeholder in their personal sub-network to cultivate it, develop it, and make it as productive as possible. This valuation technique of rewarding user-members for the value of their sub-network makes each user-member an investor in their own sub-network where they are compensated for the activity and profitability of their sub-network. This valuation technique of rewarding user-members for the value of their sub-network is a transformative evolution in magnifying the network effects for each and every user-member that enhances the defensibility of network 10. Each sub-network is valued based on the sum total of the engagement, activities, and commerce of each user-member. These relationships recorded in Merkle tree membership data record shown in FIG. 3 are permanent for the life of network 10 in order to track and record relationships 58 as well as identify and reward user-members for their sub-networks. Any user-member can refer new individuals or entities to join network 10. These new referrals are recorded into the Merkle tree with new links 56. User-members can be corporations, businesses, clubs, sports teams, limited-liability companies, joint ventures, or any other form of legal entity or human association.

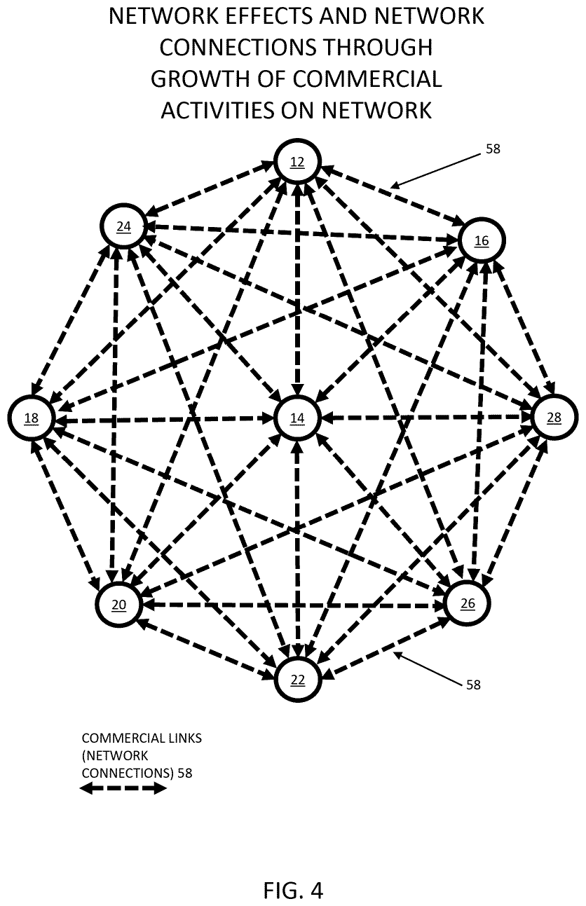

FIG. 4 illustrates a commercial network layer having an architecture in the form of a web of interconnected nodes 12, 14, 16, 18, 20, 22, 24, 26, 28, and 30 where user-members of the network 10 conduct commerce with each other that is based on network effects. When individuals or entities join network 10, their membership relationships are recorded on referral network layer 56 within a Merkle tree. Once individuals or entities have joined network 10 and are recorded as a user-member within referral layer 56, those user-members are free to interact with every other user member on network 10. The engagement of user-members across network 10 after the recordation of the referral relationships is done through commercial network layers 58, which in FIG. 4 are shown through bi-directional commercial links. User-members 12, 14, 16, 18, 20, 22, 24, 26, 28, and 30 may engage with every other user-member for commercial purposes where sellers provide commercial items of value and buyers provide payment. Commercial links 58 are not based solely on purchases but can represent any form of engagement. For example, the commercial engagement can include showing advertisements, clicking on advertisements, providing commercial referrals, clicking on product hyperlinks, forwarding hyperlinks, providing reviews, bundling with other products, or any other form of electronic commerce or electronic-engagement. In order to affect an actual electronic sale, a significant amount of electronic engagement will likely have occurred first. This electronic engagement includes any form of media, advertising, hyperlinks, or other form of electronic communication that encourages the purchase of a commercial item. It is contemplated that commercial items could be any commercial item, such as a good, service, subscription, advertising or other commercial offering has its transactions logically linked on a separate commercial layer of the network. Other commercial offerings may include commercial sales of commodities, securities, currency, digital currency, crypto coins, Non-Fungible Tokens (NFTs), or other commercial offerings. As shown in FIG. 4, network layer 58 has each node 12, 14, 16, 18, 20, 22, 24, 26, 28, and 30 of digital network 10 connected to every other node. Every additional node that joins network 10 adds a new connection for all the existing nodes, so the number of new connections (network density) increases as a square of the number of nodes (N²). One valuation method of a network is by measuring it as proportional to the square of the number of connected nodes, N², which is referred to as Metcalfe's law. Since the value of a network is proportional to its density, each additional node adds to the network value at a geometric rate. While the virality of gaining new user-members benefits network 10, it is the engagement of user-members with each other on network 10 that creates network effects that bring the most value to network 10 and each user-member. Another valuation method of a network is with Reed's law which measures the value of a network as increasing exponentially (2^{N}) in proportion to the number of user-members N that are illustrated as nodes in FIG. 4, which is much faster even than what Metcalfe's Law described. Arguably, Metcalfe's law actually understates the value of a network 10. Within a larger network 10, smaller, tighter sub-networks can form as discussed in FIG. 3. These smaller, tighter sub-networks are the inner circle within a network. Such connections, and the potential to join other subgroups, cement user-member's commitment to the overall network 10 in deeper ways than the overall size and connection density of the network would imply by themselves. It is these sub-networks that bring great value to the network effects and each member of the network. Basing financial compensation for each user-member on their sub-networks revolutionizes the reward system for user-members by rewarding user-members for the ongoing activities, engagement, and commercial activity of their sub-network. This reward system accurately measures and rewards the network effects that user-members bring to the network 10 through their sub-networks. This reward system done on a period recurring basis incentivizes user-members over the long-term to continuously engage with network 10.

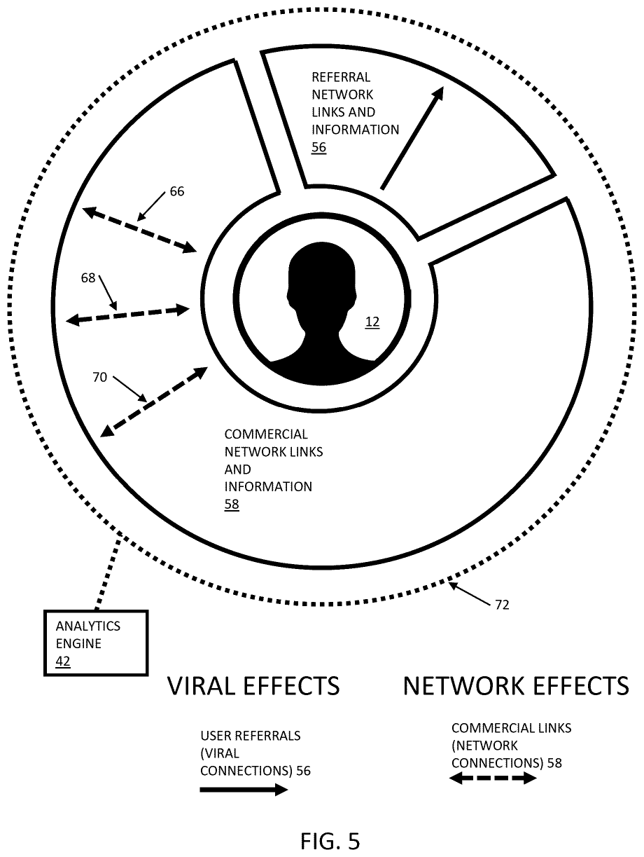

FIG. 5 diagrams a user-member 12 of the multi-layered social-commercial network 10 and that individual's relationships on the multi-layered social-commercial network 10 through the referral network layer 56 based on viral effects and the commercial network layer 58 based on network effects. Data analytics engine 42 tracks the activity, engagement, and commerce of every user-member. This tracking of user-member's activity, engagement, and commerce on network 10 with data analytics engine 42 is visualized in FIG. 5. Here, user-member 12 is examined for exemplary purposes. FIG. 5 is applicable to every user-member on network 10. User-member 12 has activity, engagement, and information recorded on referral network layer 56 recorded through links 56 within the relationship Merkle tree shown in FIG. 3. User-member 12 also has activity, engagement, information, and commerce recorded on commercial network lawyer 58 through links 58 for various separate commercial sub-layers for product 66, product 68, and subscription 70. The sum total of a user-member's engagement and activity on network 10 is a combination of their viral effects recorded in referral network layer 56 and their network effects recorded in commercial network layer 58. This sum total of a user-member's viral effects and network effects is illustrated diagrammatically as a pie chart with an image of user-member 12 in the center of the pie chart. Data analytics engine gathers, records, and analyzes all data on user-member 12 as that user-member engages in activity on network 10, which is represented by dashed circle 72 emanating from data analytics engine 42 and encompassing user-member 12 and the pie-chart of their network effects and viral effects. In order to quantify the viral effects and network effects on network 10, the process begins by measuring the viral effects and network effects for each individual user-member separately as shown in FIG. 5. By measuring and quantifying the viral effects and network effects attributable to each individual user-member, it is then possible to quantify the viral effects and network effects attributable to each sub-network possessed by each user-member. The total impact on network 10 is the summation of an individual user-member's viral effects and network effects on network 10 and the viral effects and network effects of that user-member's sub-network.

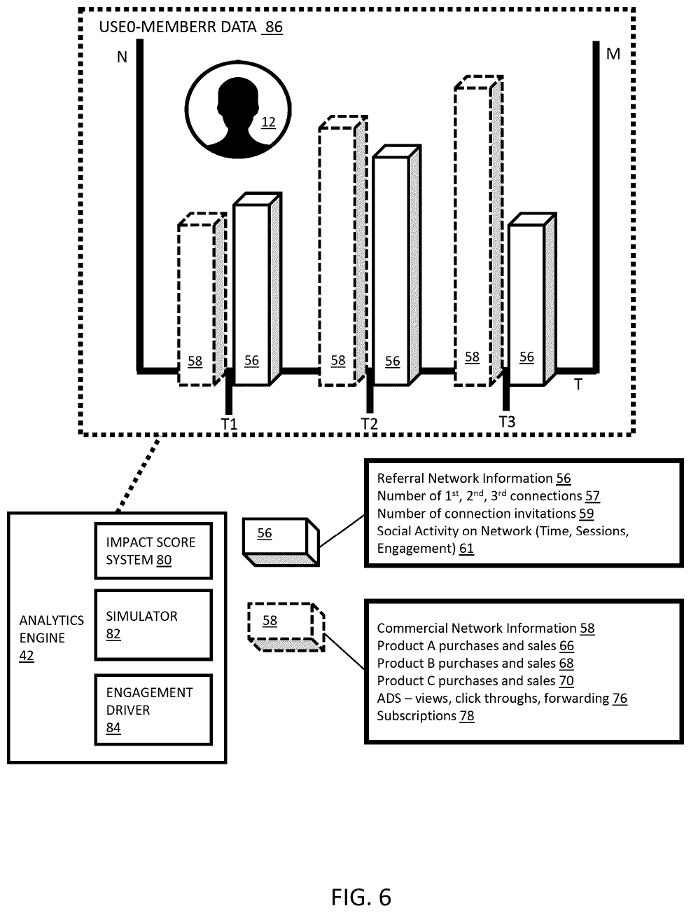

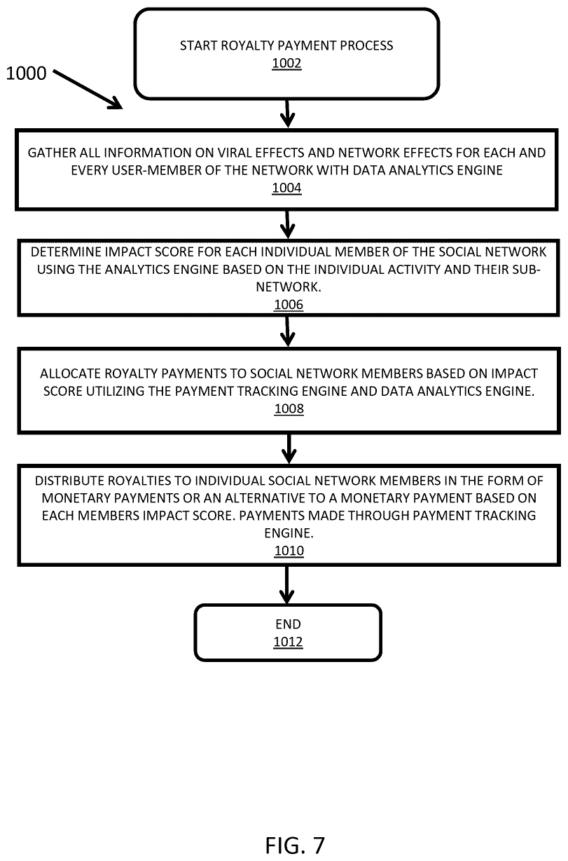

FIG. 6 illustrates the data analytics engine 42 and a schematic view of its processing of network information on viral effects, network effects, and other social-commercial network information on the referral network layer 56, the commercial network layer 58, and the remainder of the multi-layered social-commercial network 10. Data analytics engine 42 includes impact score system 80, simulator 82, and engagement driver 84. As shown in FIG. 5, data analytics engine 42 monitors the activity, engagement, and commerce of every user-member individually through monitoring 72. All of the information and data 86 gathered on each user-member is collected on a recurring periodic basis of time periods T. Time periods T can be any time duration. Similarly, the duration of time period T may be altered to different lengths. User-member data 86 is shown for user 12. The user-member data 86 for user member 12 is shown in a two y-axis bar chart for three time periods T1, T2, and T3. The bar chart shows the network effects data 58 and viral effects data 56 for user-member 12. The network effects data 58 is all of the information and data on the engagement and activities that user-member 12 performed on commercial network layer 58. The viral effects data 56 is all of the information and data on the engagement and activities that user-member 12 performed on referral network layer 56. As shown in FIG. 6, the network effects engagement data 58 of user-member 12 increased each period of time T1, T2, and T3. The viral effect data 56 of user-member 12 increased from time period T1 to T2, but decreased in T3. This data is merely exemplary for illustrative purposes. In this example, User-member 12 steadily increased their activity, engagement, and commerce on network 10 from time periods T1, T2, and T3. User-member 12 increased their referral activity of new individuals or entities to network 10 from time period T1 to T2, but decreased them in time period T3. Data analytics engine 42 gathers all of the user-member data 86 and utilizes an impact score system 80 to calculate an impact score for each and every user-member including user-member 12. This impact score is used to calculate a financial payment or value transfer to user-member 12 for each time period T for a recurring payment. In this manner, impact score system 80 provides a long-term incentive to each and every user-member to continuously engage with network 10. A detailed discussion on the creation and use of the impact score for financial payments to user-members is provided in FIGS. 7-13. Data analytics engine 42 can utilize a range of network tools in order to stimulate activity, engagement, and commerce by user-members. These tools can include utilizing user data and information to create new internal connections between user-members to increase engagement and commerce between members. These tools can also include advertisements, media, video, images, electronic communications, financial rewards, coupons, product recommendations, or other forms of electronic communication or engagement between network 10 and user members. The use of these tools within network 10 may achieve different outcomes such as growth of new members or growth of new commerce. Data analytics engine can utilize all of the aggregate user-member data 86 on all user members in a simulator 82 to predict the behavior of user-members and the likely impact of the application of the tools on the network 10 as a whole. Simulator 82 can run a variety of simulations on all different permutations of applying different types and amounts of tools of various combinations of user-members to ascertain likely outcomes. Administrators can review the outcomes of the simulator and make determinations about what courses of action to pursue in applying tools to the network 10 and its user-members. Data analytics engine 42 includes and engagement driver 84. Engagement driver 84 is the system that applies network tools to user-members to stimulate them to engage in a desired behavior. These network tools are the ones simulated by simulator 82 and include utilizing user data and information to create new internal connections between user-members to increase engagement and commerce between members. These tools can also include advertisements, media, video, images, electronic communications, financial rewards, coupons, product recommendations, or other forms of electronic communication or engagement between network 10 and user members. The viral information from referral network layer 56 includes referral network information 56, the number of 1^{st}, 2^{nd}, and 3^{rd} connections 57 in the referral Merkle tree 56, the number of connection invitations 59 that the user-member sends out to invite others to join network 10, it also includes social activity on network 61 such as the user-member's total time, sessions, and engagement on network 10, and any other viral effects information. Network effects information 58 includes commercial network information 58, product A purchases and sales 66, product B purchases and sales 68, product C purchases and sales 70, advertisement information 76 such as views, click-throughs, forwarding of media, subscription information 78, and any other network effects information.

FIG. 7 illustrates a flowchart 1000 depicting a process for paying user-members based upon their individual impact score developed from their individual activity on the multi-layered social-commercial network as well as the activity of their connections within their sub-network on the multi-layered social-commercial network. The royalty payment process begins with START 1002. In step 1004, data analytics engine 42 gathers all information on viral effects 56 and network effects 58 for each and every user-member for a time period. In step 1006, data analytics engine 42 utilizes impact score system 80 to calculate an impact score for each and every user-member based on the individual activity of each user-member and the activity of their respective sub-networks. The impact score is utilized to calculate a royalty payment to each user-member. Royalty payments may be electronic financial payments of currency, digital currency, cryptocurrency, in-network credits, coupons, NFTs, securities, stock, or any other item of value. In step 1008, the payments to user-members are allocated based upon their impact score. Different user-members may receive different forms of royalty payments based upon their preferences or financial payment amount. In step 1010, financial royalty payments are distributed to individual user-members in the form of monetary payments or an alternative form of payment through the use of the payment tracking engine 45. The payment tracking engine 45 distributes and tracks payments to all user-members. The process ENDS in step 1012. Process 1000 is performed on a recurring periodic basis. As such, user-members may receive different payment amounts for different time periods. User-members may also find that their impact score falls below a minimum threshold causing them to receive no payment for all applicable time periods to which they fail to have a minimum impact score.

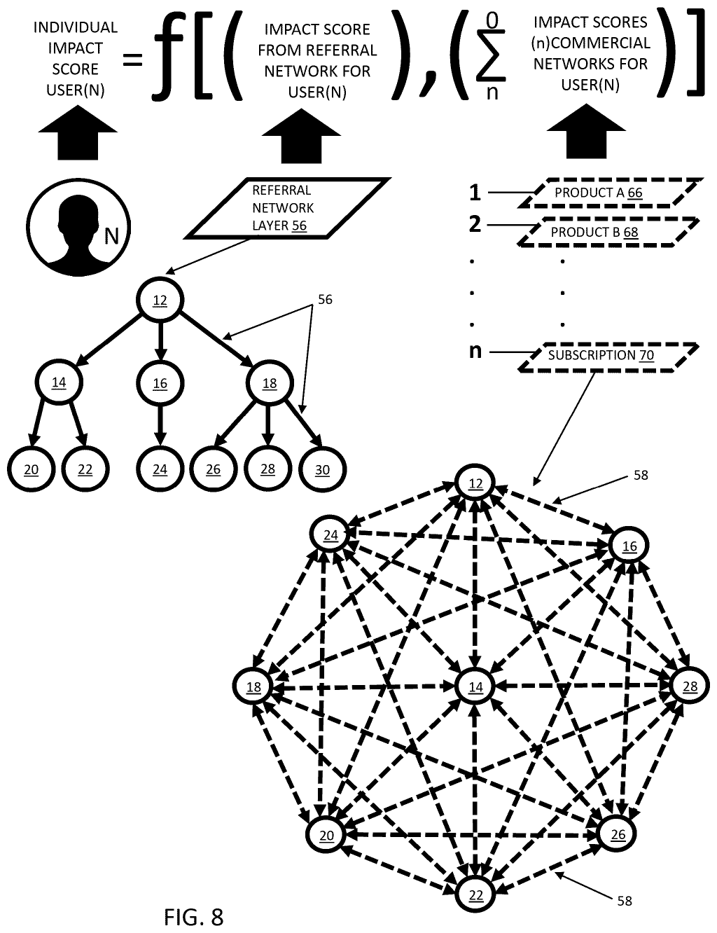

FIG. 8 illustrates the calculation of a user-member's total impact score based upon a summation of that user-member's individual impact score and the impact score based on that user-member's sub-network. The total impact score for user-member (N) is a function of the impact score from the user-member's referral network and a summation of the impact scores of the various commercial network layers that the user-member (N) is a participant. The impact score from the referral network layer 56 is based upon the referrals of new user-members that user-member (N) brought into the network 10. The user-member (N) may be a part of innumerable commercial network layers 58 for all of their various commercial activities. In this example, it includes (N) commercial network layers such as product A 66, product B 68, and subscription 70. The total impact score for user (N) is a quantification of all of the viral effects and network effects provided by user (N). The equation in FIG. 8 is the impact score for just user (N) along without including the impact of the viral effects and network effects provided by the sub-network attributable to user (N).

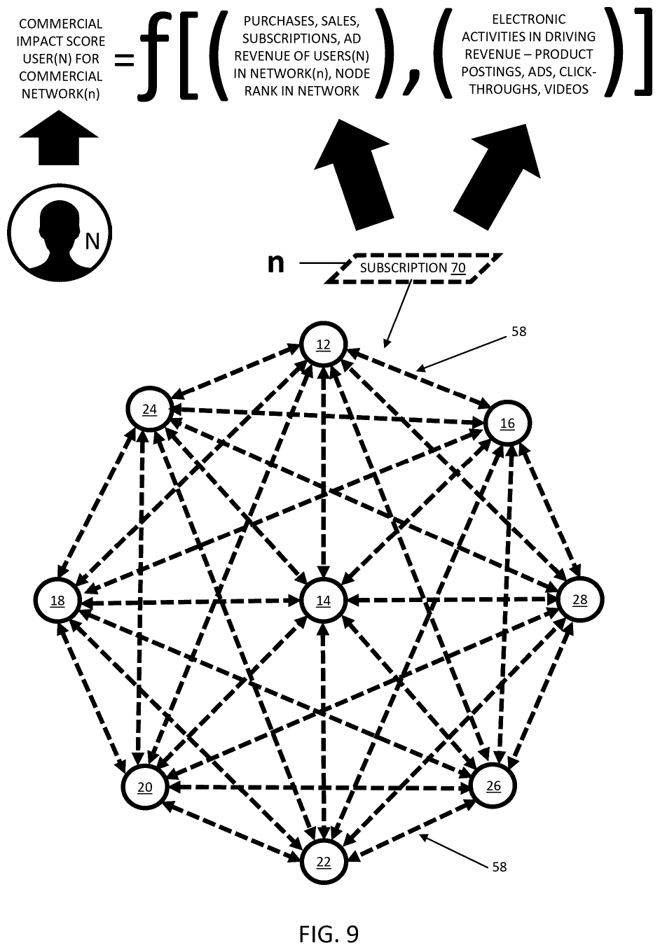

FIG. 9 illustrates the calculation of a user-member's commercial impact score that is based upon all of that user-member's commercial activities. A user-member (N)'s commercial activities are quantified for an impact score in the equation shown in FIG. 9. The commercial impact score, which represents a user-member's network effects, is a function of the purchases, sales, subscriptions, advertising revenue, and other factors based on that user-member's commercial activities. The commercial impact score is also a function of all electronic activities of the user-member (N) on network 10 including product postings, advertisements, click-throughs, media, images, and other engagement with network 10 on commercial layer 58.

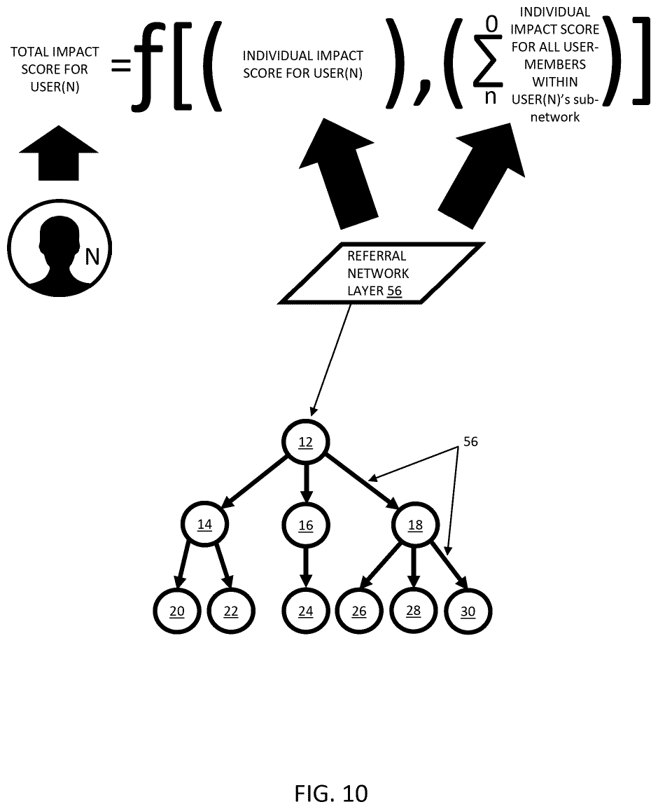

FIG. 10 illustrates the calculation of a user-member's total impact score which is based on the individual impact score for that user-member and the impact score for that user-member's sub-network. The present network provides a periodic recurring payment to each user-member based on the individual user-member's impact score and the impact score from the user-member's sub-network. As discussed above, each user-member has a sub-network of user-members that they refer into network 10. In addition, each user-member has a sub-network of user-members based on their respective commercial activities. The impact score of a user-member's sub-network is, in one exemplary embodiment, calculated as the summation of the individual user-member impact scores of all user-members within the sub-network.

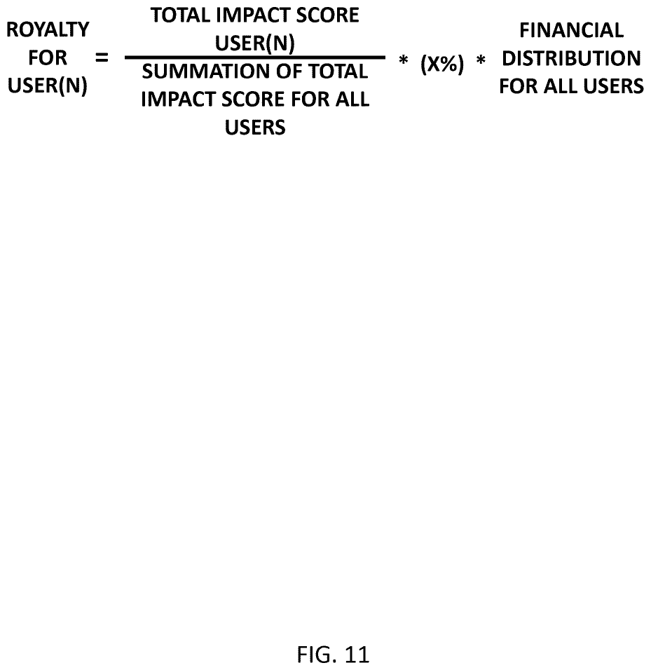

FIG. 11 illustrates an exemplary calculation of the royalty payment to a user-member based on their total impact score. In an exemplary embodiment, the royalty payment for a user-member (N) is calculated as a function of a user-member (N)'s impact score normalized by a summation of the total impact score for all user-members. That normalized impact score is then multiplied by a set percentage as set by a financial administrator and a total sum of financial distributions set aside for payment to all user-members.

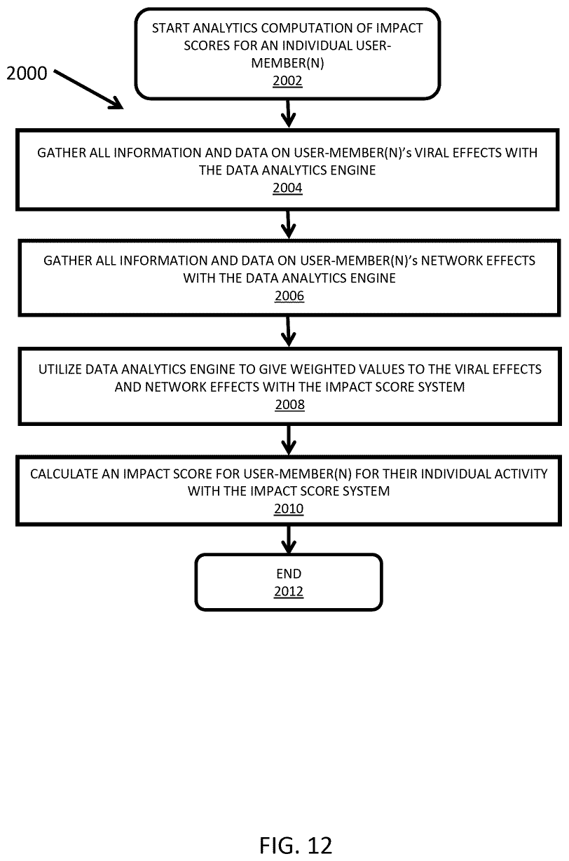

FIG. 12 illustrates a flowchart 2000 depicting a process for computing an individual impact score for a user-member. The individual impact score reflects the total engagement that a single user-member has with network 10 without considering the impact of their sub-network. The total impact score for an individual user-member is the combination of that individual user-member's impact score and the impact score of their sub-network. The impact score of their sub-network is a weighted impact score based on a summation of the impact score of all user-member's within the sub-network. The process begins within START 2002. In step 2004, the data analytics engine 42 gathers all information and data on user-member (n)'s viral effects. In step 2006, the data analytics engine 42 gathers all information and data on user-member (n)'s network effects. In step 2008, the data analytics engine 42 gives weighted values to the viral effects and network effects with the impact score system 80. In step 2010, the impact score system 80 calculates an impact score for user-member (n) for their individual activity with the impact score system based upon the weighted values for the viral effects and the network effects. The process ENDS with step 2012.

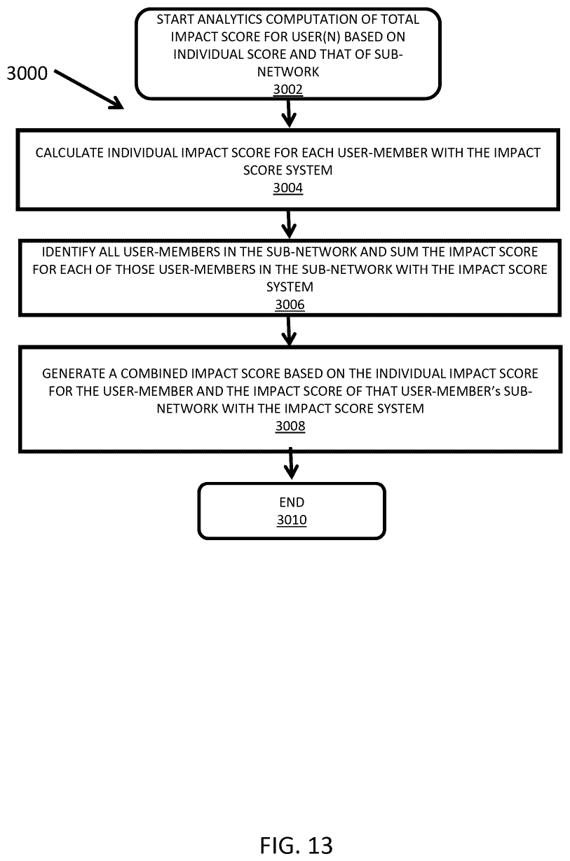

FIG. 13 illustrates a flowchart 3000 depicting a process for computing a total impact score for a user-member based upon their individual score and the impact score of their sub-network. The process to calculate the total impact score for user-member (n) based on that user-member's individual score and that of the sub-network belonging to that user-member begins with START in step 3002. In step 3004, the impact score system 80 calculates the individual impact score for each user-member. In step 3006, the impact score system 80 identifies all user-members in the sub-network for the particular user-member from step 3002 and sums the impact score for each of those user-members in the sub-network to develop a weighted impact score for the sub-network. In step 3008, the impact score system 80 generates a combined impact score based on the individual impact score for the user-member and the impact score of that user-member's sub-network. The process ENDS in step 3010.

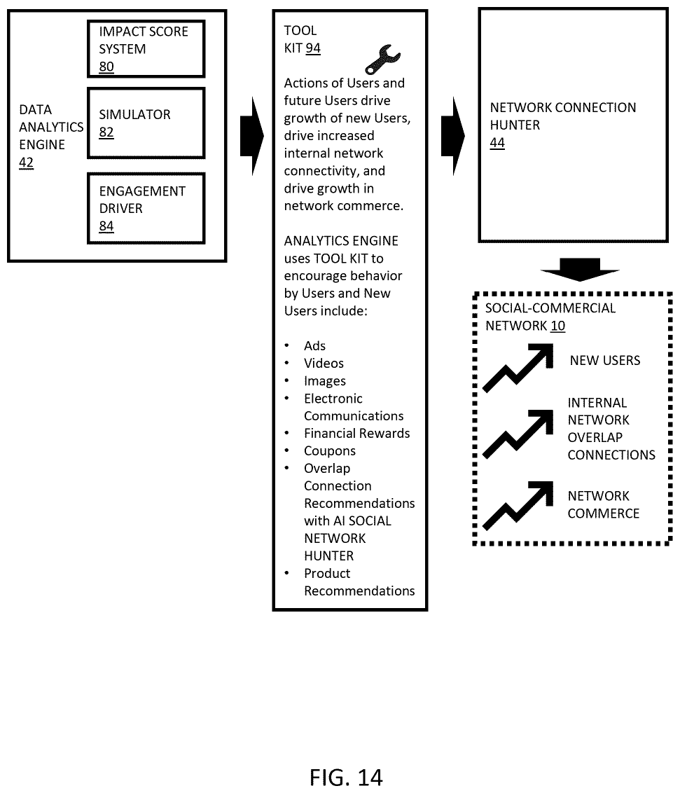

FIG. 14 illustrates a schematic flow diagram of how the data analytics engine 42 utilizes a social-commercial network tool kit 94 in combination with a network connection hunter 44 to stimulate and grow the multi-layered social-commercial network through new user-members, new connections between user-members, and increasing network commerce. Data analytics engine 42 includes impact score system 80, simulator 82, and engagement driver 84. Data analytics engine 42 gathers all information on all user-members of network 10. Data analytics engine 42 utilizes simulator 82 to predict the behavior of user-members and network 10 as a whole in response to the use of network tool kit 94. Network tool kit 94 is a set of actions that the data analytics engine may employ to interact directly with each user-member on an individual basis, in sub-groups less than all user-members, or with the network 10 as a whole. The individual actions of each user-member, and collective actions of groups of user-members, and that of all user-members determine the value and vibrancy of network 10 to each user-member and the platform supporting network 10. The more active and engaged user-members are with each other through greater network effects, the more value there is for each user-member and the network 10 as a whole. The self-starting initiative of each user-member is a primary source of activity and engagement on network 10. However, network 10 may employ the use of various tools from tool kit 94 to stimulate activity and engagement on the part of user-members individual, as a sub-group less than all user-members, or from all user-members as a whole. The digital electronic tools available to network 10 in tool kit 94 include advertisements, media, video, images, electronic communications, hyperlinks, instant-messages, email messages, SMS messages, IMESSAGE®, financial rewards, coupons, non-financial rewards, new connection recommendations, product or service recommendations, or any other form of electronic engagement or communication. Deploying one or more tools from tool kit 94 will cause the user-members within network 10 to engage in various behavior. Data analytics 42 can predict the likely behavior of user-members in response to the use of various types and quantities of tools from tool kit 94 using simulator 82 and the history of user-member data gathered from data analytics engine 42 that records actual user-member responses to the use of tool kit 94 in past engagements. The network 10 may be programmed to achieve various goals such as focusing on network 10 growth, growth of internal connections between user-members, or growth of network commerce. While it may be desired to focus on all of these three key goals for network 10, focusing on all three at once may overwhelm user-members and not lead to the strongest path for network 10 growth. It may prove more desirable to run the network 10 for a period to maximize new user-member growth through viral effects. Subsequently, after a new member drive, it may prove optimal to switch from new user-member growth to drive an increase in new internal connections between existing user-members. While user-members may all exist on network 10, that does not mean they are all in connection and communication with each other. The greater the amount of internal connections between user-members within network 10, the larger the amount of network effects are present bringing greater value to network 10. Thus, it is highly desirable to develop internal connections between user-members, particularly more robust connections based on shared interests, needs, or commercial activities. The greater the depth of internal connections between user-members, the greater the amount of commerce that can occur within network 10. To optimize growth in network 10 and maximize commerce to bring greater financial value to each user-member through network effects, simulator 80 may determine that there are various combinations and cycles of new user-member drives, drives for growth in internal connections, and drives for increased commerce that result in optimal growth for network 10. Simulator 80 can run all permutations of utilizing tool kit 94 to engage with user-members to determine the optimal combination of tool types and quantity to deploy with user-members to engage with them and stimulate desired behavior to achieve the desired goals for network 10. When data analytics engine 42 uses simulator 80 to determine the optimal or desired combination of actions to deploy with tool kit 94, the analytics engine 42 may use engagement driver 84 to select tools from tool kit 94 to actually deploy with respect to each user-member individually, in groups, or as a whole to cause network 10 to add new user-members, to grow internal network overlap connections to increase network effects, and increase commerce. When seeking to achieve these goals for network 10, data analytics engine 42 may also employ network connection hunter 44. Network connection hunter 44 is a tool that searches for data and information among user-members that would indicate a possible new connection between user-members that does not yet exist. This new connection can be based on any commonly shared interest, activity, or form of engagement by user-members. For example, certain user-members who are not connected within network 10 may search for common information for food, travel, sports, or hobbies suggesting a potential new connection. Certain user-members who are not connected may have biographical data that suggests a potential new connection such as a common educational institution, a common type of work, a common geographic location, or a common conference. Network connection hunter 44 searches all data for all user-members to identify potential connections for existing user-members and recommends these connections to user-members. A percentage of user-members will accept these recommendations. A percentage of those user-members who accept these recommended connections will actually engage across the new connection through messages or commerce. Network connection hunter 44 will gather information on these successful new connections recommended by it to determine what types of connections are likely to result in accepted and active new connections that increase network effects for the network 10. Each new connection that results in more engagement between user-members and more commerce increases the network effects for network 10, thereby enhancing the value of network 10 for each user-member. Network connection hunter 44 can recommend new potential user-members based on metadata from each existing user-member such as their cell-phone contact list, contact list from email or social media accounts, or a contact list from any other source. Network connection hunter 44 can gather private data on each existing user-member from any connected device associated with each user-member to try to identify new user-members to add to network 10 as a new user-member. Network connection hunter 44 may then also seek to identify new connections between existing members to boost the number of internal connections within network 10, which boosts the density of the network 10 and its network effects in proportion by a factor X to the square of the number of connections on the network 10, shown below in Equation 1.

DENSITY OF NETWORK=X*(NUMBER OF INTERNAL CONNECTIONS)² EQN. 1:

Network connection hunter 44 may be powered by data analytics rules supported by an administrator for setting parameters. Alternatively, network connection hunter 44 may be programmed by artificial intelligence (AI) or machine learning (ML) to maximize the number of active connections on network 10 and keep recommending new connections to user-members and then monitoring those suggestions to see which ones actually get accepted and become active. An AI or ML network connection hunter 44 can then gather and study data to predictively determine which possible connections are likely to get accepted and become active to more successfully offer up connections to user-members to increase the network effects in a more efficient and predictive manner. Further, user-members will prove more likely to accept new suggested connections if those suggestions are of high quality that would result in acceptance, engagement, and commerce.

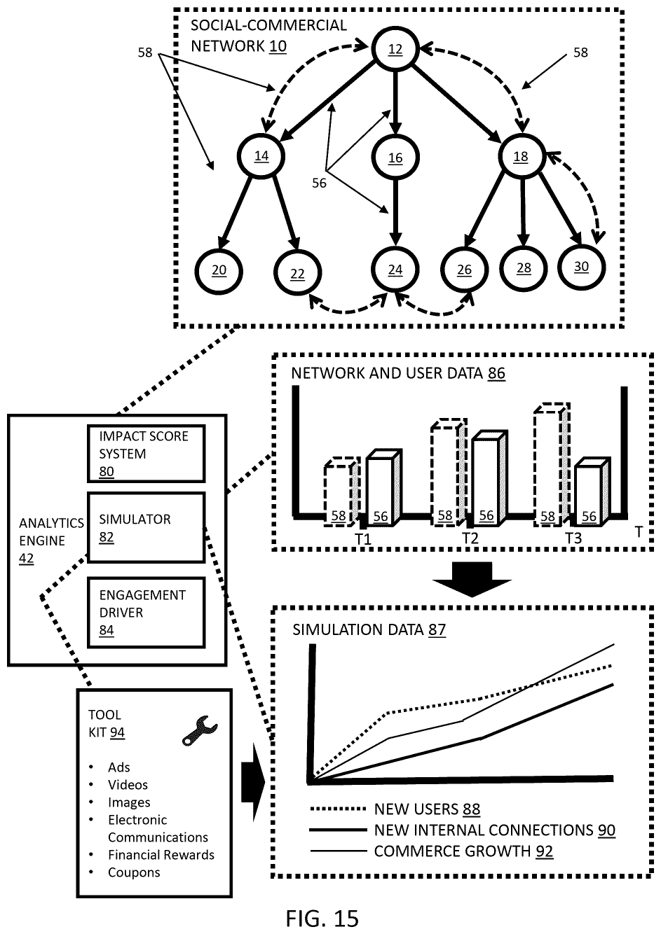

FIG. 15 illustrates a schematic flow diagram depicting how the data analytics engine 42 gathers data from the multi-layered social-commercial network and uses that data with the simulator 80 to determine how use of the network tool kit 94 can stimulate activity and growth in the multi-layered social-commercial network 10 through new user-members, new internal connections, and commercial growth, which is used to guide actions by the multi-layered social-commercial network 10 with interacting with user-members. At the top of FIG. 15 is a diagrammatic representation of a social-commercial network 10 with user-members portrayed as nodes within a Merkle tree for representation of the referral relationships between user-members shown in solid lines 56. The mesh network of user-members engaged with each other on network 10 for commercial activities or other engagement is shown by bi-directional dashed lines 58. Data analytics engine 42 monitors and records all data and information of each user-member and network 10 and analyzes it producing network and user data 86, which is shown providing data and statistics on viral effects 56 and network effects 58 for three different time periods T1, T2, and T3, which are periodic recurring time periods such as hours, days, weeks, months, or years. Simulator 82 utilizes the historic network and user data 86 in combination with predictive algorithms, machine learning, or artificial intelligence to predict the future behavior of user-members and network 10 in response to the application of tools from tool kit 94. The results of this simulation are in the form of simulation data 87, which shows predictive trends for growth in new user-members 88, new internal connections 90, and growth in commerce 92 based on the application of predictive artificial intelligence, machine learning, or data analytics. An administrator may review the simulation data 87 and instruct data analytics engine 42 on which course of action to take with applying what tools from tool kit 94 in what duration and quantity to achieve the predictive results projected by simulation data 87. Alternatively, data analytics engine 42 may be programmed to achieve certain goals and will select which course of action to deploy tools from tool kit 94 in response to the simulation data 87. Alternatively, data analytics engine 42 may be powered by machine learning or artificial intelligence and will automatically select which course of action to take in deploying tools from tool kit 94 in order to achieve the optimal goals for network 10.

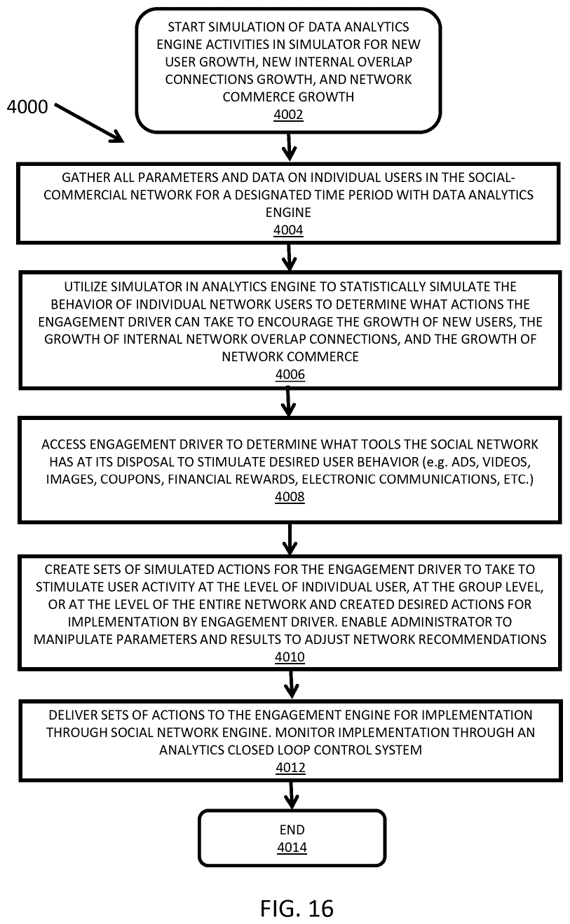

FIG. 16 illustrates a flowchart 4000 depicting a process for simulating the behavior of the multi-layered social-commercial network with a simulator 82 on the data analytics engine 42 to project user growth, growth of internal overall connections, and growth of network commerce based on the application of the network tool kit 94. The process of simulation of data analytics engine activities in a simulator for new user growth, new internal overlap connections growth, and network commerce growth begins with START 4002. In step 4004, the data analytics engine 42 gathers all parameters and data on individual user-members in the social-commercial network for a designated time period. In step 4006, the data analytics engine 42 utilizes simulator 82 to statistically simulate the behavior of individual network user-members to determine what actions the engagement driver 84 can take to encourage the growth of new user-members, the growth of internal network overlap connections, and the growth of network commerce. In step 4008, the data analytics engine 42 accesses engagement driver 84 to determine what tools the social-commercial network 10 has at its disposal in tool kit 94 to stimulate desired user behavior such as ads, videos, images, coupons, financial rewards, electronic communications, new internal connection recommendations, or other electronic forms of engagement. In step 4010, data analytics engine 42 creates sets of simulated actions for the engagement driver 84 to take to stimulate user activity at the level of individual users, at the group level, or the level of the entire network 10 and creates desired actions for implementation by engagement driver 84. The data analytics engine 42 also enables an administrator to manipulate parameters and results to adjust these network recommendations. Alternatively, artificial intelligence or machine learning may utilize their logic to review and implement the results of the simulation through engagement driver 84 and tool kit 94 upon network 10. In step 4012, the data analytics engine 42 delivers sets of actions to the engagement driver 84 for implementation on network 10 with tool kit 94. The data analytics engine 42 monitors the implementation of these actions in combination with tool kit 94 through a closed-loop control system to ensure that the implementation of these actions results in the desired outcome goals set by an administrator for new user-member growth, new connection growth, or new commerce growth. The process ENDS with step 4014.

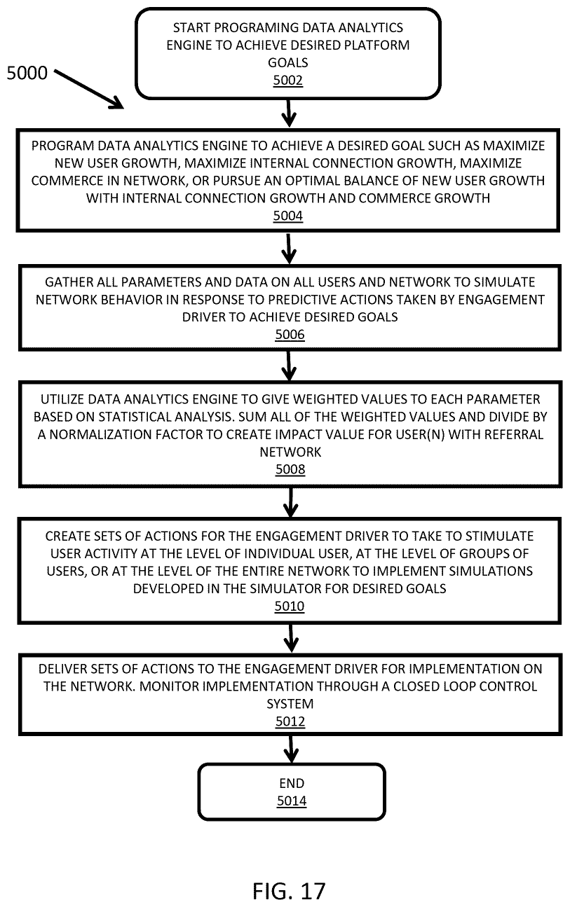

FIG. 17 illustrates a flowchart 5000 depicting a process for programming the data analytics engine to achieve desired goals for the multi-layered social-commercial network such as new user growth, growth of internal connections, or growth of network commerce. The process of programming data analytics engine 42 to achieve desired platform goals for network 10 begins with START 5002. In step 5004, the data analytics engine 42 is programmed to achieve a desired goal such as maximizing new user growth, maximizing internal connection growth, maximizing commerce in a network, or pursuing an optimal balance of new user growth with internal connection growth and commerce growth. In step 5006, the data analytics engine 42 gathers all parameters and data 86 on all users and networks to simulate network behavior in response to predictive actions taken by engagement driver 84 to achieve desired goals. In step 5008, data analytics engine 42 gives weighted values to each parameter gathered on user-members based on statistical analysis. Data analytics engine 42 sums all of the weighted values and divides by a normalization factor to create an impact value for user (n) with referral network with impact score system 80. In step 5010, data analytics engine 42 creates sets of actions for the engagement driver 84 to take to stimulate user activity at the level of individual user-member, at the level of groups of user-members, or at the level of the entire network 10 to implement simulations developed in the simulator for desired goals. In step 5012, the data analytics engine 42 delivers sets of actions with the use of tool kit 94 to the engagement driver 84 for implementation on the network 10 based upon the simulation data 87 produced by simulator 82. Data analytics engine 42 monitors implementation of tool kit 94 on network 10 through a closed loop control system that tracks the resulting behavior of network 10 in response to the actions taken with engagement driver 84 with tool kit 94. The process ENDS with step 5014.

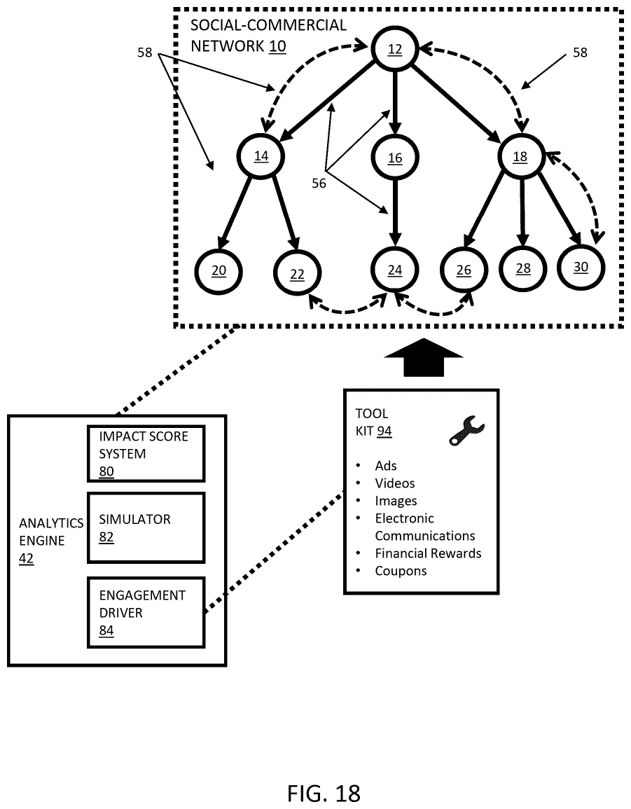

FIG. 18 illustrates a schematic flow diagram showing the data analytics engine 42 utilizing the tool kit 94 to engage with users of the multi-layered social-commercial network 10 to generate user activity in conformance with the programmed goals for the multi-layered social-commercial network 10 as simulated by the data analytics engine 42. Once the data analytics engine 42 selects a set of actions to implement on network 10 with tool kit 94, data analytics engine 42 employs engagement driver 84 in combination with tool kit 94 to deploy selected tools on network 10. In this schematic representation, data analytics engine 42 monitors and gathers data on network 10 to utilize historical data within simulator 82 to determine what actions to take to achieve desired goals. Once desired actions are determined, data analytics engine 42 utilizes engagement driver 84 to deploy the use of tools 94 on network 10. The deployment of tools from tool kit 94 on network 10 results in a change in behaviors of user-members on network 10. This change in behaviors of user-members on network 10 is monitored by data analytics engine 42 in a data closed-loop control system formed by network 10 and data analytics engine 42. The data analytics engine 42 then employs this new data gathered in network 10 in response to the application of tool kit 94 to further refine the simulations in simulator 82 to develop new additional instructions for engagement driver 84 to deploy tool kit 94 on network 10.

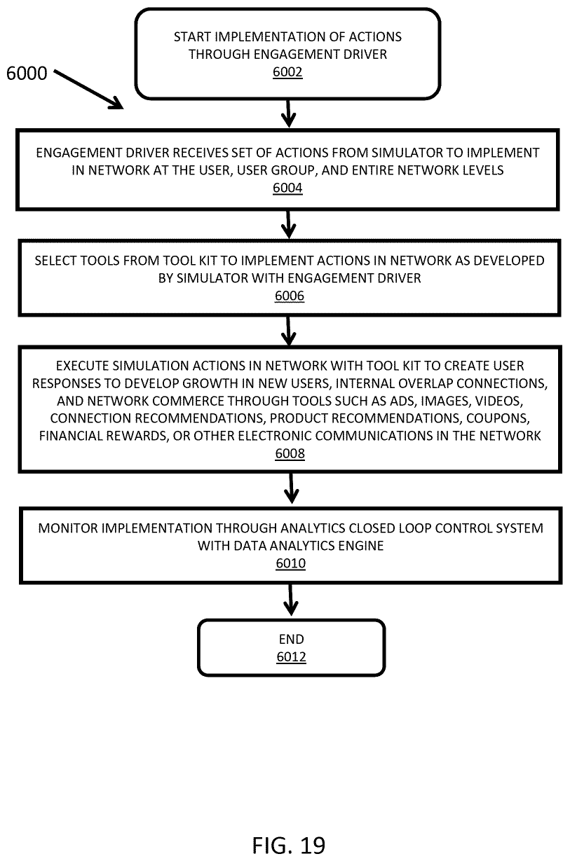

FIG. 19 illustrates a flowchart 6000 depicting a process for the data analytics engine 42 using the network tool kit 94 to implement engagement actions with the social-commercial network 10 through engagement driver 84. The process of implementing actions through engagement driver 84 with tool kit 94 begins with START in step 6002. In step 6004, engagement driver 84 receives sets of actions from simulator 82 and data analytics engine 42 to implement in network 10 at the user, user group, and entire network levels. In step 6006, engagement driver 84 selects tools from tool kit 94 to implement actions in network 10 as developed by simulator 82 with engagement driver 84. In step 6008, engagement driver 84 executes simulation actions in network 10 with tool kit 94 to create user actual real responses from user-members 12, 14, 16, 18, 20, 22, 24, 26, 28, and 30 to develop growth in new users, internal overlap connections, and network commerce through tools such as ads, images, videos, connection recommendations, product recommendations, coupons, financial rewards, or other electronic communications in the network 10. In step 6010, data analytics engine 42 monitors the implementation of the tool kit 94 on network 10 through a closed loop control system through the data analytics engine that implements tools upon network 10, monitors the results of that implantation through data gathering, then refines the implementation of tools on network 10 with new instructions, and subsequently repeats the process to guide the network 10 to achieve desired goals.

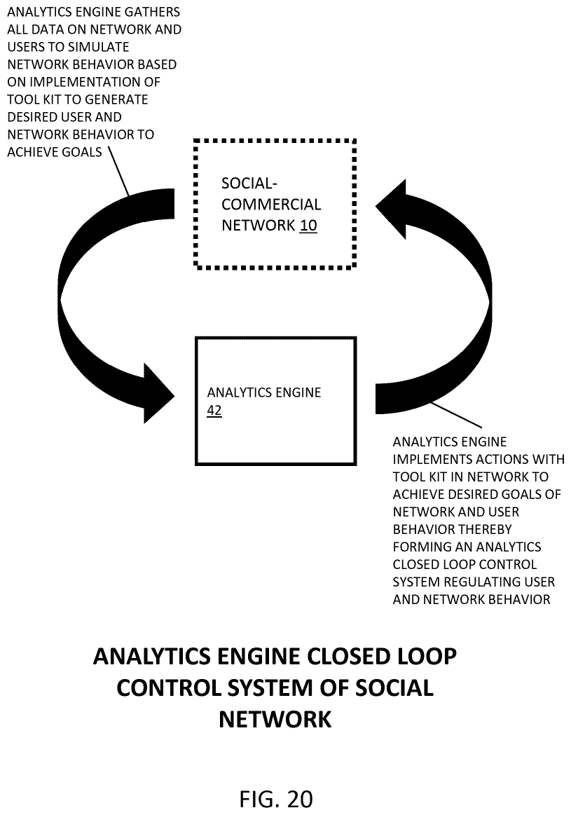

FIG. 20 illustrates a schematic flow diagram depicting how the data analytics engine 42 forms a closed-loop control system for the multi-layered social-commercial network 10. Data analytics engine 42 forms a closed-loop control system with network 10. Data analytics engine 42 gathers information and data on all behavior on network 10 including each and every individual user-member. Data analytics engine 42 subsequently categorizes and analyzes this gathered information and data to determine who to stimulate desired behavior by the user-members with tool kit 94 and engagement driver 84. The data analytics engine 84 subsequently uses engagement driver 84 to deploy took kit 94 on network 10 to drive and stimulate behavior from user-members to achieve desired goals for network 10. Data analytics engine 42 then monitors the behavior of user-members on network 10 in response to the application of tool kit 94. The process then continues in a closed-loop control system to continue developing new and improved actions for implementation of applying tool kit 94 to network 10.

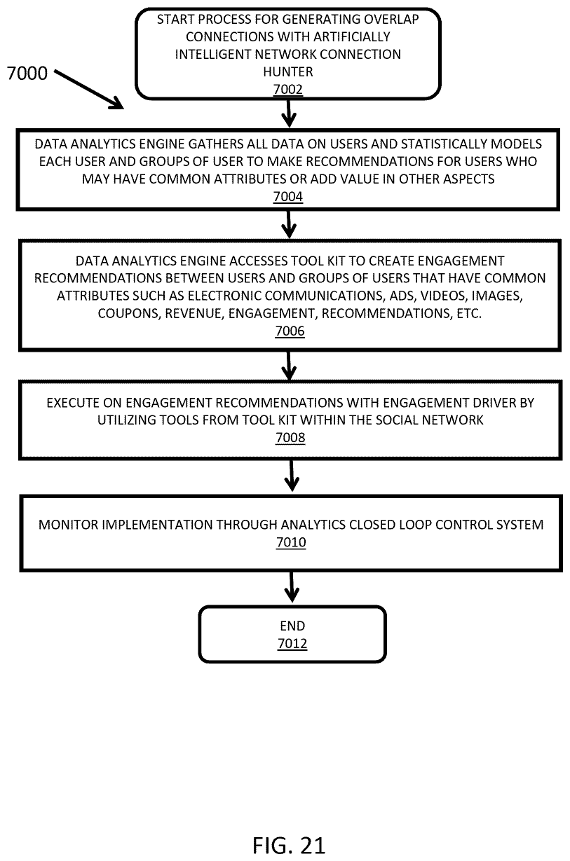

FIG. 21 illustrates a flowchart 7000 depicting a process for generating overlap connections with an artificially intelligent network connection hunter 44. The process of for generating overlap connections with artificially intelligent network connection hunter 44 begins with START 7002. Network connection hunter 44 may be powered by data analytics rules controlled by an administrator, machine learning, or in a preferred embodiment, artificial intelligence. In step 7004, data analytics engine gathers all data on users and statistically models each user and groups of users to make recommendations for users who may have common attributes or add value in other aspects. In step 7006, data analytics engine 42 accesses tool kit 94 to create engagement recommendations between users and groups of users that have common attributes such as electronic communications, ads, videos, images, coupons, revenue, engagement, recommendations, etc. for implementation by engagement driver 84. In step 7008, data analytics engine 42 executes engagement recommendations with engagement driver 84 by utilizing tools from tool kit 94 within the network 10. In step 7010, data analytics engine 42 monitors implementation of tool kit 94 on network 10 through analytics closed-loop control system described in FIG. 20 formed by network 10 and data analytics engine 42. The process ENDS with step 7014.

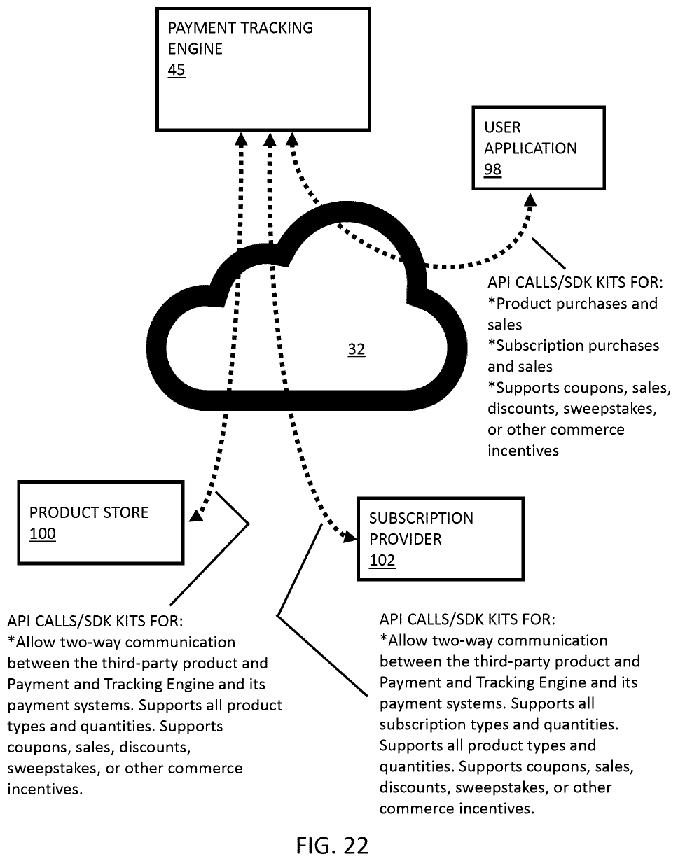

FIG. 22 illustrates a schematic diagram of a payment engine 45 with the multi-layered social-commercial network 10 interacting and bi-directionally communicating across the cloud 32 with product stores 100, subscription providers 102, and user applications 98 through Software Development Kits (SDKs) and Application Programming Interfaces (APIs) allowing product stores 100, subscription providers 102, and users of the multi-layered social-commercial network 10 to engage with each other for commercial activities. A software development kit (SDK) is a collection of software development tools in an installable package. It is used for developing applications provided by hardware and software providers. SDKs are usually comprised of application programming interfaces (APIs), sample code, and documentation. SDKs allow developers to create software or applications for a specific platform, operating system, computer system or device. SDKs are often the backbone of many popular applications, games, and apps and are provided by the manufacturer of (usually) a hardware platform, operating system (OS), or programming language. Communications between payment tracking engine 45, product store 100, subscription provider 103, and user application 98 are bi-directional through cloud 32. Payment tracking engine 45 is a part of network 10. Product store 100 is a type of business associated with a user-member on network 10 that provides commercial items of value to other user-members, such as goods. Subscription provider 102 is a type of business associated with a user-member on network 10 that provides commercial items of value to other user-members, such as video streaming. User application 98 is a typical application that a user-member would install on a mobile device such as a cellular phone, mobile watch, or desktop computer. For product store 100, the API calls and SDK kits allow two-way communication between the third-party product store 100 and payment and tracking engine 45 and its payment systems. The API calls and SDK kits support all product types and quantities including coupons, sales, discounts, sweepstakes, or other commerce incentives. For subscription provider 102, the API calls and SDK kits allow two-way communication between the third-party subscription providers 102 and payment and tracking engine 45 and its payment systems. The API calls and SDK kits support all product types and quantities including coupons, sales, discounts, sweepstakes, or other commerce incentives. For user application 98, the API calls and SDK kits allow for product purchases and sales, subscription purchases and sales, as well as providing coupons, sales, discounts, sweepstakes, or other commercial incentives.

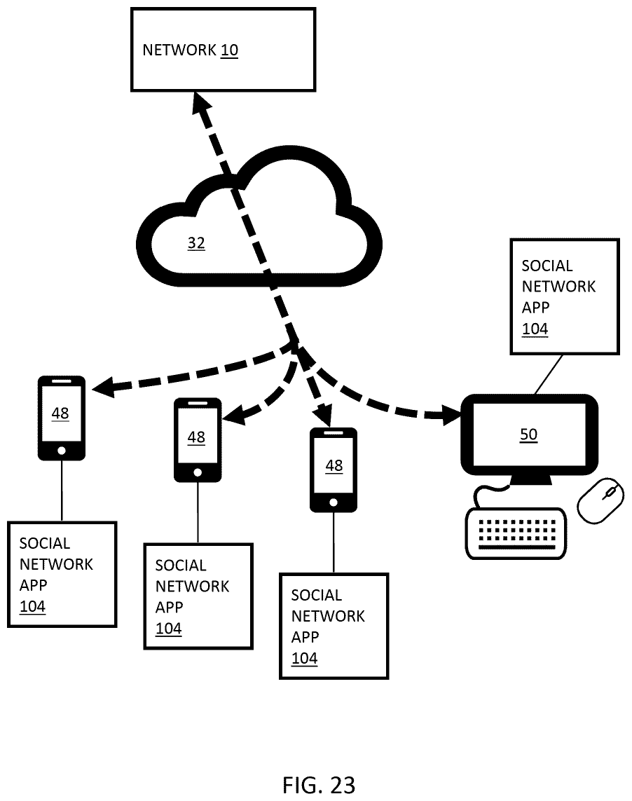

FIG. 23 illustrates a schematic diagram of a social-commercial network 10 bi-directionally communicating with applications 104 allowing user users to engage with the multi-layered social network 10 from mobile devices 48 and computer workstations 50 such as desktop 50 and laptop computers 50. Network 10 bi-directionally communicates with network applications 104 through cloud 32. Network applications 104 allows for user-members to engage with network 10 and perform activities on network 10 such as communicating with network 10 and other user-members such as selling or buying goods or services. The various applications 104 running on devices 48 and 50 communicate with each other and network 10 bi-directionally through cloud 32.

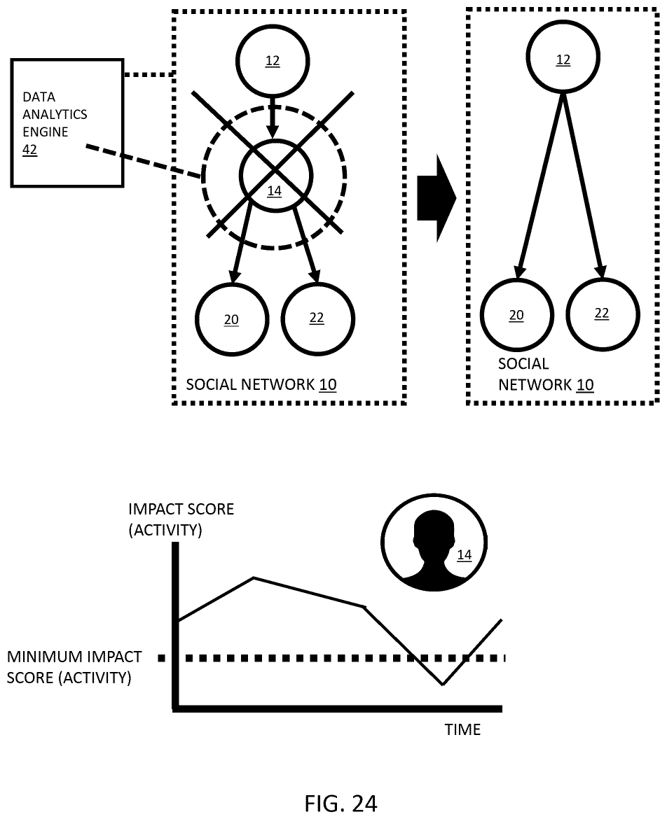

FIG. 24 illustrates a schematic drawing of utilizing a data analytics engine 42 in the multi-layered social-commercial network 10 to gauge the impact score of individual user-members within the multi-layered social-commercial network 10 to determine when to collapse social network structures 56 to remove dormant user-member nodes 14 from payment calculations based on whether individual user-member nodes maintain a minimum impact score above a preset threshold. The use of user-member node 14 as a dormant node is merely exemplary, any number of nodes in a member structure 56 may prove dormant in any given time period and will fluctuate from time period to time period. In the course of the operation of network 10, different user-members will engage with network 10 in different amounts of activity. Some user-members will engage with network 10 at very high levels. An average level of activity will be performed a many user-members. Some user-members will engage with network 10 at very minimal levels. Other user-members may not engage in any activity on network 10. Indeed, some user-members may prove fake or “zombie” accounts. In order to accurately and precisely compensate user-members for their engagement with network 10 through viral effects or network effects, it is desirable to weed out those user-members whose engagement with network 10 is non-existent or falls below a minimum threshold. In this schematic diagram, user-member 14 joined network 10 at the referral of user-member 12. User-member 14 then referred user-members 20 and 22 to join network 10. The Merkle tree membership record showing this referral relationship is shown in FIG. 24. Data analytics engine 42 monitors the engagement and activity of each user-member 12, 14, 20, and 22. In this case, user-member 14 has a level of activity and engagement with network 10 that falls below a minimum threshold. This level of engagement may be measured through the impact score for the individual user that does not include the sub-network impact score attributable to user-member 14 as discussed in FIG. 8. In this example, because the individual impact score for user 14 is below a minimum threshold, data analytics engine 42 will make a calculation for financial payment distributions by removing user-member 14 from the referral network layer 56. As shown at the bottom of FIG. 24, the activity level of user 14 will fluctuate over time. This level of activity is quantified through the individual impact score for user 14. While the sub-network of user-member 14 may remain active during the inactivity of user-member 14, it may not be desirable to reward user-members for the activity of their sub-network when they themselves are inactive on network 10. To incentivize every user-member to participate in and engage with network 10, it is desirable to penalize inactive user-members by preventing them from being included in financial distributions for any time period during which they are inactive. In the chart at the bottom of FIG. 24, user-member 14 is shown to have a time-varying level of activity quantified with an impact score. A minimum impact score threshold is set that user-member 14 fell below a period of time. The user-member 14 then had their activity rise above that minimum threshold subsequent to that period of time. In this network 10, user-member 14 may lose inclusion in payment periods for a period of time during which the user-member 14 has an impact score below the minimum threshold. Once the activity level of user-member 14 exceeds the minimum threshold, user-member 14 may once again be included in financial payment distributions. For purposes of payment calculations, user-member 14 is removed from the Merkle tree and is collapsed into a network that includes just user-members 12, 20, and 22 as shown in the upper right corner of FIG. 24.

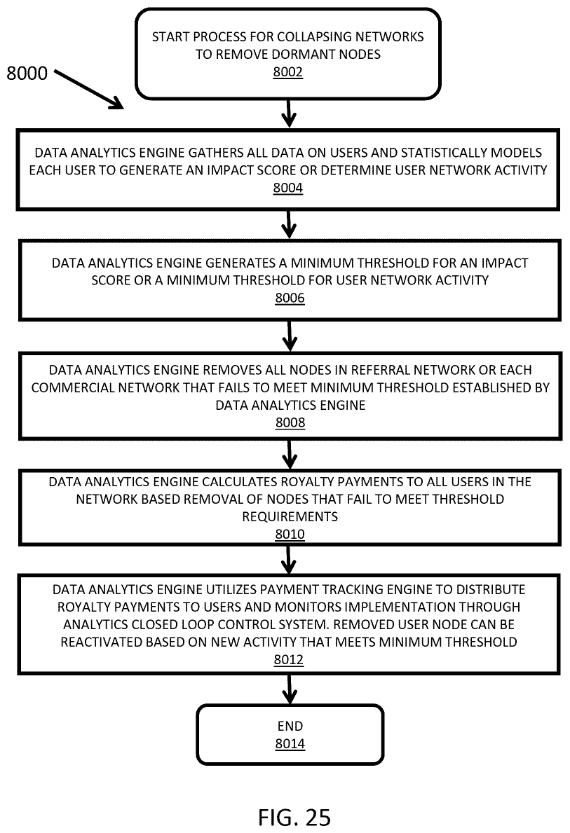

FIG. 25 illustrates a flowchart 8000 depicting a process for collapsing social network structures 56 to remove dormant user nodes for payment calculations based on whether individual user nodes maintain a minimum impact score above a preset threshold. The process of collapsing networks to remove dormant nodes begins with START 8002. In step 8004, data analytics engine 42 gathers all data on user-members and statistically models each user-member to generate an impact score or quantify user-member network activity. In step 8006, data analytics engine 42 generates a minimum threshold for an impact score or a minimum threshold for user network activity. This minimum threshold may be developed by machine learning or artificial intelligence to select a bottom percentile of user-members who are engaging in activity below a minimum desired level. Alternatively, an administrator may select a preset minimum threshold for an impact score for user-members. This minimum threshold for an impact score sets a bar of activity that each user-member must engage in to be able to be considered within a financial payment distribution for a period of time. This minimum threshold functions as a direct incentive to compel user-members to engage in a minimum desired amount of network activity or face the consequence of having their account excluded from consideration for financial payment distributions. In step 8008, data analytics engine 42 removes all nodes in referral network 56 or each commercial network 58 that fails to meet the minimum threshold established by data analytics engine 42. In step 8010, data analytics engine 42 calculates royalty payments to all user-members in the network 10 based removal of nodes that fail to meet threshold requirements, such as user-member node 14 in FIG. 24. In step 8012, data analytics engine 42 utilizes payment tracking engine 45 to distribute royalty payments to user-members and monitors the implementation of payments to user-members through analytics closed-loop control system discussed in FIG. 20. Removed user nodes can be reactivated based on a new activity that meets the minimum threshold for a succeeding time period. It is not desirable to permanently ban a user-member from succeeding payments for failing to meet the minimum threshold for activity for a period of time. A permanent ban provides no incentives to inactive user-members to become active again. By allowing a user-member to exceed the minimum threshold in a later time period and receive a financial payment, user-members are incentivized to become active again after a period of time for which they become inactive. Inactivity may occur for a variety of reasons such as work, illness, vacation, or a desire to engage in other legitimate pursuits. The process ENDS with step 8014.

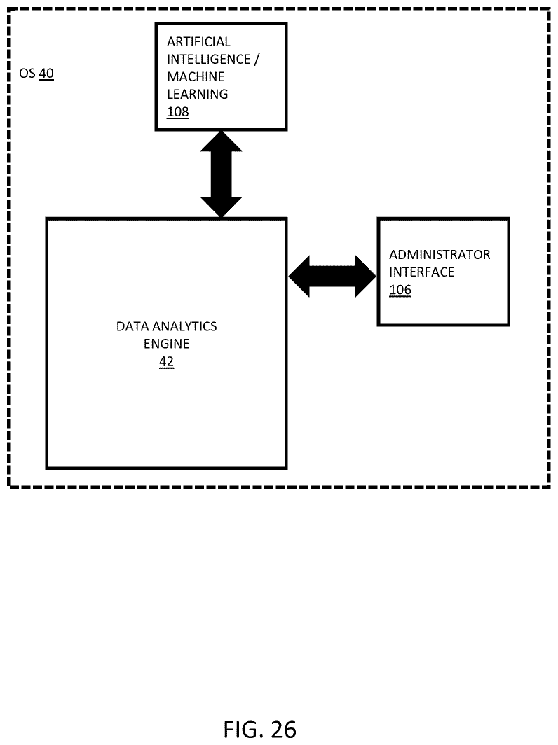

FIG. 26 illustrates a block diagram of a data analytics engine 42 on the multi-layered social-commercial network 10 and its interconnected administrator interface 106 and artificial intelligence/machine learning unit 108 that all execute on operating system 40. Data analytics engine 42 is utilized to set goals for network 10 and utilizes simulator 82 to ascertain the best actions with tool kit 94 to pursue and achieve those goals. Selection of these actions may occur automatically through a rule-based programmed into data analytics engine 42. An administrator may interact with data analytics engine 42 through administrator interface 106 in which an administrator can set various parameters in data analytics engine 42 such as goals for new user growth, new connections growth, new commerce growth, or an optimized balance of these goals. The administrator could also set the minimum threshold for user-member impact scores for consideration in making financial distributions to user-members. Data analytics engine 42 may communicate with a system containing artificial intelligence or machine learning in order to allow network 10 to make more refined independent decisions for network 10 based on AI or machine learning.

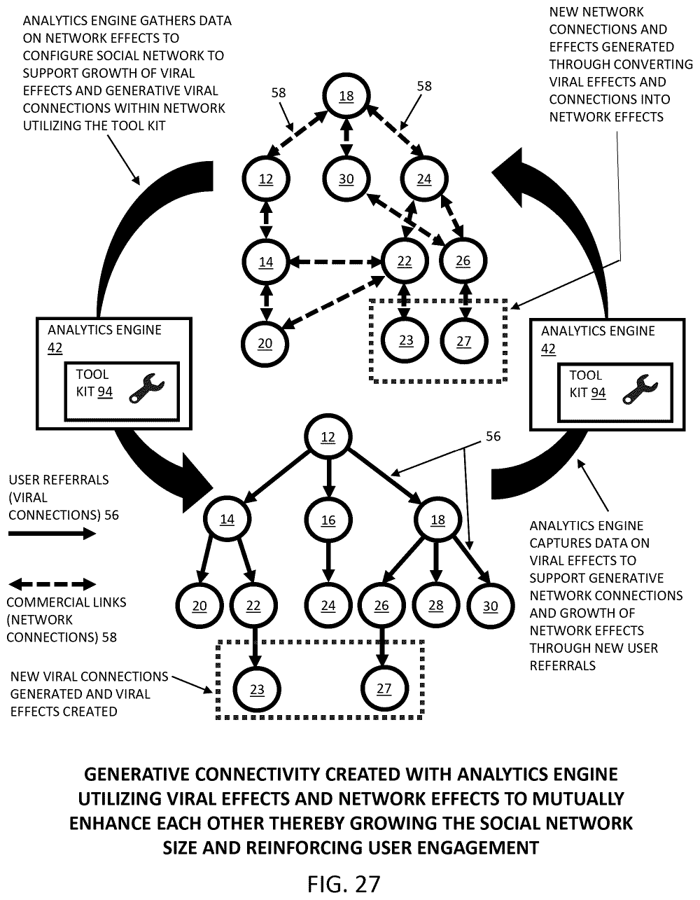

FIG. 27 illustrates a schematic of a process for generative connectivity creation with a data analytics engine 42 using viral effects and network effects to mutually enhance each other, thereby growing the social-commercial network 10 size and value by reinforcing user-member engagement. Under network theory, every additional node that joins network 10 adds a new connection for all the existing nodes, so the number of new connections (network density) increases as a square of the number of nodes (N²). One valuation method of a network is by measuring it as proportional to the square of the number of connected nodes, N², which is referred to as Metcalfe's law. Since the value of a network is proportional to its density, each additional node adds to the network value at a geometric rate. While the virality of gaining new user-members benefits network 10, it is the engagement of user-members with each other on network 10 that creates network effects that bring the most value to network 10 and each user-member. Another valuation method of a network is Reed's law which measures the value of a network as increasing exponentially (2^{N}) in proportion to the number of user-members N that are illustrated as nodes in FIG. 4, which is much faster even than what Metcalfe's Law described. Arguably, Metcalfe's law actually understates the value of a network 10. Within a larger network 10, smaller, tighter sub-networks can form. These smaller, tighter sub-networks are the inner circle within a network. Such connections, and the potential to join other subgroups, cement user-member's commitment to the overall network 10 in deeper ways than the overall size and connection density of the network would imply by themselves. It is these sub-networks that bring great value to the network effects and each member of the network. While the presence of additional user-member nodes enhances the value of a network 10 through viral effects and network effects, it is the number of connections that emanate from each additional user-member node as well as the activity of each user-member that dictates the amount of network effects on network 10. One method of quantifying the network effects of user-members is by measuring network density as being directly proportional to an exponentially growing value based on the number of connections C from each node N as shown below in Equation 2.

NETWORK DENSITYα2^{(C*N)} EQN. 2:

It is possible to then add value to network 10 by increasing both the number of user-members as well as increasing the connections between user-members. The greater the network density, the greater the value of the network to each user-member, thereby increasing the network effects and defensibility of the network 10. To increase the number of user-members and increase the connections between user-members, it is desirable to increase the viral effects on network 10 as well as the network effects of user 10. FIG. 27 illustrates that network 10 is configured to take advantage of viral effects and network effects through the cyclical application of tool kit 94 to alternate between magnifying viral effects and network effects. This cyclical application of viral effects and network effects allows network 10 to utilize viral effects and data on viral effects to configure network 10 to prime it for enhanced network effects. Similarly, the cyclical application of viral effects and network effects allows network 10 to utilize network effects and data on network effects to configure network 10 to prime it for enhanced viral effects. The top center of FIG. 27 illustrates network effects 58 on a commercial network layer of network 10 where nodes 18, 12, 30, 24, 14, 22, 26, and 20 are engaged in commerce. Data analytics engine 42 gathers data on network effects in layer 58 to support the growth of viral effects and generative viral connections utilizing tool kit 94. Applying tool kit 94 to network 10 to stimulate new user-member to join network 10 and other viral effects results in new user-member 23 joining at the invitation of existing user-member 22 as well as new user-member 27 joining at the invitation of existing user-member 26. Data analytics engine 42 captures data on viral effects to support generative network connections and growth of network effects through creating connections between these new user-members 23 and 27 with the remainder of network 10 through the application of tool kit 94. Through applying tool kit 94, data analytics engine 42 can capture these new user-members 23 and 27 and integrate them into the commerce and other activity on network 10 in order to engage them and make them active network participants who gain and add value to network 10 through their engagement. If new user-members 23 and 27 are not actively engaged after joining network 10, it is possible they will fade as a temporary viral effect. Viral effects are often discounted in network analysis due to the fact that new users join, but do not remain an active part of the network. This network 10 seeks to create improved viral effects where new user-members are actively engaged at the moment of their virality to expose them to network effects to convert the viral nature of these new user-members into long-term network effects through active engagement. In this example, data analytics engine 42 creates new network connections on commerce layer 58 to connect new user-members 23 and 27 to network 10 on commerce layer 58, thereby engaging them through network effects to bring them value through being on network 10 as well as additional value to all other existing user-members.

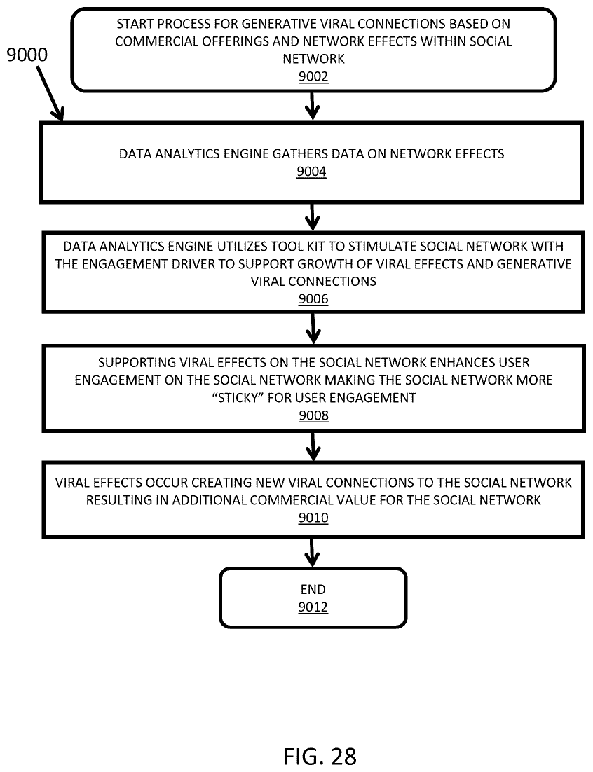

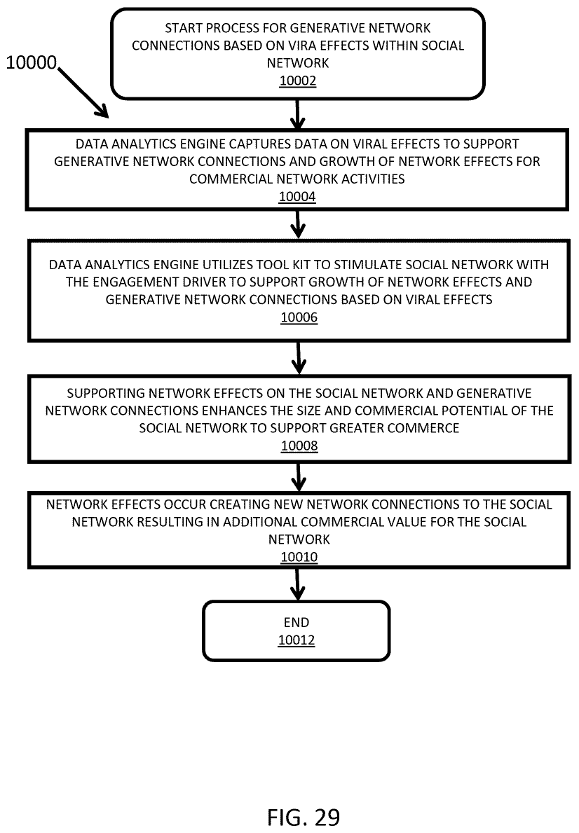

FIG. 28 illustrates a flowchart 9000 depicting a process for generative viral connection creation based on commercial offerings and network effects within social-commercial network 10. The process for generative viral connections based on commercial offerings and network effects within social-commercial network 10 begins with START in step 9002. In step 9004, data analytics engine 42 gathers data on network effects from network 10. In step 9006, data analytics engine 42 utilizes tool kit 94 to stimulate social-commercial network 10 with the engagement driver 84 to support the growth of viral effects and generative viral connections. In step 9008, supporting viral effects on the social-commercial network 10 enhances user engagement on the social-commercial network 10 making the social-commercial network 10 more “sticky” for user engagement. In step 9010, viral effects occur creating new viral connections to the social-commercial network 10 resulting in additional commercial value for the social-commercial network 10. This portion of the cyclical nature of utilizing network effects to grow and magnify viral effects ENDS with step 9012. The next portion of the cyclical effort of using viral effects to grow and magnify network effects is shown in FIG. 29.

FIG. 29 illustrates a flowchart 10000 depicting a process for generative network connection creation based on viral effects within a social-commercial network 10. The process for generative network connections based on viral effects within social-commercial network 10 begins with START 10002. In step 10004, data analytics engine 42 captures data on viral effects to support generative network connections and growth of network effects for commercial network activities on layer 58. In step 10006, data analytics engine 42 utilizes tool kit 94 to stimulate social network 10 with the engagement driver 84 to support growth of network effects and generative network connections based on viral effects. In step 10008, supporting network effects on the social-commercial network 10 and generative network connections enhance the size and commercial potential of the social-commercial network 10 to support greater commerce. In step 10010, network effects occur creating new network connections to the social-commercial network 10 resulting in additional commercial value for the social-commercial network 10. The process ENDS with step 10012.

While one or more embodiments of the present invention have been illustrated in detail, one of ordinary skill in the art will appreciate that modifications and adaptations to those embodiments may be made without departing from the scope of the present invention as set forth in the following claims.

1. A non-transitory computer-readable storage medium containing instructions for a method of determining a periodic payment to users of a social network based on a combination of network effects and viral effects attributable to that user, comprising:
associating users of a cloud-based social network into a Merkle tree structure based on an order of membership referrals as to which user referred which to a cloud-based social network;
quantifying an amount of digital engagement that a first user has with the cloud-based social network through an individual impact score;
attributing all users that were referred to the cloud-based social network by the first user into a sub-network the first user;
quantifying an amount of digital engagement that all users within the sub-network of the first user have with the cloud-based social network through a sub-network impact score; and
making a recurring electronic payment to the first user on a periodic basis utilizing the individual impact score and the sub-network impact score.

2. The non-transitory computer-readable storage medium containing instructions for the method of claim 1, wherein the digital engagement includes at least one of hyperlink click-throughs, viewing digital media, viewing digital advertisements, viewing time spent on the cloud-based social network, posting of digital material on the cloud-based social network, or commercial activity on the cloud-based social network.

3. The non-transitory computer-readable storage medium containing instructions for the method of claim 2, wherein the individual impact score and the sub-network impact score are recalculated for the first user and the sub-network of the first user on a periodic basis.

4. The non-transitory computer-readable storage medium containing instructions for the method of claim 3, wherein the digital engagement is a measure of network effects attributable to the first user and the sub-network of the first user, wherein inclusion of the sub-network of the first-user is a measure of the viral effects attributable to the first user.

5. The non-transitory computer-readable storage medium containing instructions for the method of claim 4, wherein a data analytics engine in communication with the cloud-based social network acquires data on the first user and the sub-network of the first user to determine the amount of digital engagement for the first user and the sub-network of the first user, wherein the data analytics engine generates the individual impact score and sub-network impact score utilizing artificial intelligence or machine learning.

6. A non-transitory computer-readable storage medium containing instructions for a multilayered social network utilizing a combination of network effects and viral effects for growth of the multilayered social network, comprising:
utilizing network effects to drive users of a cloud-based social network to add new users to the cloud-based social network;
capturing digital information on all users of the cloud-based social network;
utilizing a data analytics engine to generate viral effects within the cloud-based social network to increase commerce within the cloud-based social network; and
capturing digital information on the viral effects to generate new network effects for existing users of the cloud-based social network for adding additional new users to the cloud-based social network.

7. The non-transitory computer-readable storage medium containing instructions for a multilayered social network of claim 6, the cloud-based social network further comprising:
a referral network layer where users are linked together into a Merkle tree based upon the user that referred them to the cloud-based social network; and
a commercial network layer where users are dynamically linked to other users based upon commercial activity without regard to which user referred them to the cloud-based social network.

8. The non-transitory computer-readable storage medium containing instructions for a multilayered social network of claim 7, the cloud-based social network further comprising:
an artificially intelligent social network connection hunter that generates internal connections between existing users of the cloud-based social network to support viral effects within the cloud-based social network, wherein the artificially intelligent social network connection hunter generates internal connections based on data gathered from the existing users of the cloud-based social network.

9. The non-transitory computer-readable storage medium containing instructions for a multilayered social network of claim 7, the cloud-based social network further comprising:
a data analytics payment engine that monitors cloud-based social networking activity of each user within the cloud-based social network, wherein the data analytics payment engine assigns an impact score to each individual user based upon their total engagement activity online with the cloud-based social network, wherein the data analytics payment engine distributes financial payments to users that have an impact score above a minimum threshold, wherein the data analytics payment engine does not distribute financial payments to users that have an impact score below a minimum threshold.

10. The non-transitory computer-readable storage medium containing instructions for a multilayered social network of claim 9, wherein the impact score includes the cloud-based social networking activity of other users that can trace their referral back to the user receiving an impact score such that the impact score reflects the activities of the user in question and all users within their social network.

11. The non-transitory computer-readable storage medium containing instructions for a multilayered social network of claim 10, the cloud-based social network further comprising a cloud-based social network simulator in which an artificial intelligence engine can simulate behavior of users within the cloud-based social network in response to application of stimulus applied by the cloud-based social network to one or more users.

12. A non-transitory computer-readable storage medium containing instructions for a method of selecting nodes within a digital social network for participation with financial payment distributions based upon individual impact scores for each node, comprising:
capturing digital network activity data for each node of a cloud-based digital social network utilizing a data analytics engine;
assigning an individual impact score for each node based on the digital network activity data of that node; and
distributing financial payments to each node based on each node's individual impact score.

13. The non-transitory computer-readable storage medium containing instructions for the method of claim 12, further comprising:
wherein the digital network activity data includes one or more digital network activity types including at least one of: electronic communications between nodes, electronic transactions between nodes, electronic purchases between nodes, offering for sale products or services to other nodes, viewing electronic media from other nodes, expanding the size of the digital social network by adding new users as nodes of the digital social network, or any other form of electronic network activity between nodes of the digital social network.

14. The non-transitory computer-readable storage medium containing instructions for the method of claim 13, wherein each digital network activity type is assigned a score, wherein each score varies based upon a level of activity for a particular digital network activity type.

15. The non-transitory computer-readable storage medium containing instructions for the method of claim 14, wherein the individual impact score is a weighted summation of the assigned scores for the various types of digital network activity types engaged in by each individual node.

16. The non-transitory computer-readable storage medium containing instructions for the method of claim 15, wherein nodes that fail to have an impact score that rises above a minimum threshold are excluded from receiving a financial payment distribution.

17. The non-transitory computer-readable storage medium containing instructions for the method of claim 16, wherein a node that does not have an impact score that rises above a minimum threshold and is excluded from a financial payment distribution for a first payment period may receive a financial payment distribution for a second payment period when the impact score for that node rises above the minimum threshold.

18. A non-transitory computer-readable storage medium containing instructions for generative connectivity between nodes of a digital social network through artificial intelligence, comprising:
associating users of a cloud-based social network into a Merkle tree structure based on an order of membership referrals as to which user referred which to the cloud-based social network, wherein the Merkle tree structure forms a first layer of the cloud-based social network;
tracking commercial activities of the users on the cloud-based social network, wherein the commercial activities form a second layer of the cloud-based social network;
acquiring data on the commercial activities of the users with artificial intelligence to quantify network effects based on digital engagement of the users with the cloud-based social network;
utilizing information on the network effects to generate new user connections based on viral effects;
acquiring data on the commercial activities of the users with the artificial intelligence to quantify viral effects based on digital engagement of the users with the cloud-based social network; and
utilizing information on the viral effects to generate new user connections based on network effects.

19. The non-transitory computer-readable storage medium containing instructions for generative connectivity of claim 18, wherein the network effects include at least one of: electronic communications between nodes, electronic transactions between nodes, electronic purchases between nodes, offering for sale products or services to other nodes, viewing electronic media from other nodes, or any other form of electronic network activity between nodes of the digital social network.

20. The non-transitory computer-readable storage medium containing instructions for generative connectivity of claim 19, wherein the viral effects include expanding the size of the digital social network by adding new users as nodes of the digital social network, wherein an analytics engine utilizes a network tool kit to generate new user connections based on viral effects, wherein the analytics engine utilizes a network tool kit to generate new user connections based on network effects, wherein the network tool kit includes advertisements, videos, media, images, electronic messaging, coupons, financial rewards, product recommendations, or other form of user digital engagement.
